(19) United States
(12) Patent Application Publication
(10) Pub. No.: US 2024/0250732 A1
(43) Pub. Date: Jul. 25, 2024

(54) BEAM REPORTING FOR NON-SERVING CELLS

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN)

(21) Appl. No.: 18/560,802

(22) PCT Filed: May 14, 2021
(86) PCT No.: PCT/CN2021/093836

§ 371 Date: Nov. 14, 2023

(51) Int. Cl. H04B 7/06

(52) U.S. Cl. CPC H04B 7/0626

(57) ABSTRACT

Methods and apparatuses for beam reporting for non-serving cells are disclosed. A method comprises receiving a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and transmitting a CSI report including K CRIs or SSBRIs and the measured L1-RSRP value of the resource associated with a non-serving cell indicated by each of the K CRIs or SSBRIs.

### FIELD

The subject matter disclosed herein generally relates to wireless communications, and more particularly relates to methods and apparatuses for beam reporting for non-serving cells.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), handover (HO), Channel State Information (CSI), Channel State Information Reference Signal (CSI-RS), CSI-RS Resource Indicator (CRI), Synchronization Signal Block (SSB), SSB resource indicator (SSBRI), Downlink control information (DCI), Transmission Reference Point (TRP), Physical Downlink Shared Channel (PDSCH), Reference Signal Receiving Power (RSRP), Layer 1 Reference Signal Received Power (L1-RSRP), channel measurement resource (CMR), non zero power (NZP), CSI-RS resource set indicator (CRSI), SSB resource set indicator (SSBRSI), Information Element (IE), physical cell ID (PCID).

Traditional handover (HO) procedure for a UE moving across multiple cells specified in NR Release 15 is based on beam or cell measurement and report in RRC layer, which leads larger HO latency and larger signaling overhead. To reduce the latency and overhead, it was agreed that a UE can report one or more beams and the corresponding measured L1-RSRP values associated with one or more non-serving cells in a CSI report in physical layer.

This disclosure targets the configuration for beam management for non-serving cells.

### BRIEF SUMMARY

Methods and apparatuses for beam reporting for non-serving cells are disclosed.

In one embodiment, a method comprises receiving a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and transmitting a CSI report including K CRIs or SSBRIs and the measured L1-RSRP value of the resource associated with a non-serving cell indicated by each of the K CRIs or SSBRIs.

In one embodiment, one CMR set including resources associated with one or more non-serving cell(s) is configured. The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In another embodiment, a multiple of CMR sets, each of which includes resources associated with a different non-serving cell, are configured. The resource indicated by each of the K CRIs or SSBRIs is associated with any of the CMR sets. Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In some embodiment, the CSI-ReportConfig IE further has nrofReportedRS indicating the number N of beams associated with a serving cell, N is 1 or more, and the CSI report further includes N CRIs or SSBRIs and the measured L1-RSRP value of the resource associated with the serving cell indicated by each of the N CRIs or SSBRIs.

In one embodiment, one CMR set including two subsets is configured, a first subset of the two subsets includes resources associated with the serving cell and a second subset of the two subsets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In another embodiment, two CMR sets are configured, a first CMR set of the two CMR sets includes resources associated with the serving cell, and a second CMR set of the two CMR sets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell. In some embodiment, the largest measured L1-RSRP value of the resources associated with the first CMR set is quantized to a 7-bit value in the range [−140, −44] dBm with step size of 1 dB, each of the other measured L1-RSRP values of the resource(s) associated with the first CMR set is represented by a differential L1-RSRP value, which is quantized to a 4-bit value with step size of 2 dB, relative to the largest measured L1-RSRP value of the resources associated with the first CMR set, while the largest measured L1-RSRP value of the resources associated with the second CMR set is quantized to a 7-bit value in the range [−140, −44] dBm with step size of 1 dB, each of the other measured L1-RSRP values of the resource(s) associated with the second CMR set is represented by a differential L1-RSRP value, which is quantized to a 4-bit value with step size of 2 dB relative to the largest measured L1-RSRP value of the resources associated with the second CMR set.

In some embodiment, the resources associated with a different non-serving cell are associated with a different PCID, and the resources associated with a same non-serving cell are associated with a same PCID.

In one embodiment, a method comprises transmitting a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and receiving a CSI report including K CRIs or SSBRIs and the measured L1-RSRP value of the resource associated with a non-serving cell indicated by each of the K CRIs or SSBRIs.

In another embodiment, a remote unit (UE) comprises a receiver that receives a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and a transmitter that transmits a CSI report including K CRIs or SSBRIs and the measured L1-RSRP value of the resource associated with a non-serving cell indicated by each of the K CRIs or SSBRIs.

In yet another embodiment, a base unit comprises a transmitter that transmits a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and a receiver that receives a CSI report including K CRIs or SSBRIs and the measured L1-RSRP value of the resource associated with a non-serving cell indicated by each of the K CRIs or SSBRIs.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of the resource setting and the CSI reports according to a first sub-embodiment of a first embodiment;

FIG. 2 illustrates an example of the resource setting and the CSI reports according to a second sub-embodiment of the first embodiment;

FIG. 3 illustrates another example of the resource setting and the CSI reports according to the second sub-embodiment of the first embodiment;

FIG. 4 illustrates an example of the resource setting and the CSI reports according to a third sub-embodiment of the first embodiment;

FIG. 5 illustrates another example of the resource setting and the CSI reports according to the third sub-embodiment of the first embodiment;

FIG. 6 illustrates an example of the resource setting and the CSI reports according to a fourth sub-embodiment of the first embodiment;

FIG. 7 illustrates an example of the resource setting and the CSI reports according to a second sub-embodiment of a second embodiment;

FIG. 8 illustrates an example of the resource setting and the CSI reports according to a third sub-embodiment of the second embodiment;

FIG. 9 illustrates another example of the resource setting and the CSI reports according to the third sub-embodiment of the second embodiment;

FIG. 10 illustrates an example of the resource setting and the CSI reports according to a fourth sub-embodiment of the second embodiment;

FIG. 11 illustrates an example of the resource setting and the CSI reports according to a fifth sub-embodiment of the second embodiment;

FIG. 12 illustrates another example of the resource setting and the CSI reports according to the fifth sub-embodiment of the second embodiment;

FIG. 13 is a schematic flow chart diagram illustrating an embodiment of a method;

FIG. 14 is a schematic flow chart diagram illustrating a further embodiment of a method; and

FIG. 15 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The resource setting and how to report beams for non-serving cell(s) for a CSI report are discussed in the present disclosure. The resource setting is used to configure the resources and/or the resource sets associated with a CSI reporting configured by the CSI-ReportConfig IE for channel and/or interference measurement. The RRC signaling CSI-ReportConfig IE configures aspects of a CSI report.

According to a first embodiment, one CSI report is dedicated for beam report for non-serving cell(s).

In a first sub-embodiment of the first embodiment, one channel measurement resource (CMR) set is configured in a resource setting for channel measurement for a CSI report. Best K beams are reported in the CSI report.

The resource setting for channel measurement is associated with a CSI-ReportConfig IE, which configures a CSI Report and has a higher layer parameter reportQuantity (which configures the report contents in the CSI Report), and a higher layer parameter nrofReportedRS-Neighboring (which configures the number of reported beams of the non-serving cells in the CSI Report). In the present disclosure, the number of reported beams of the non-serving cells is denoted as K.

The one CMR set (also referred to as “the CMR set”) can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’). All of the SSB resources or NZP CSI-RS resources may be from or be associated with one or multiple non-serving cells.

The number of CMR resources (i.e. SSB resources or NZP CSI-RS resources) in the CMR set is denoted as K_{S}.

The best beam(s) refers to the NZP CSI-RS resource(s) having the largest measured L1-RSRP value(s). In the CSI Report according to the first sub-embodiment of the first embodiment, K CRIs or SSBRIs that indicate K NZP CSI-RS resources or SSB resources having K largest measured L1-RSRP values and the K measured L1-RSRP values are reported. A CRI is used to indicate an NZP CSI-RS resource. A SSBRI is used to indicate a SSB resource.

The bit width of each of K CRIs or SSBRIs in the CSI report is determined by ┌log₂(K_{S})┐, which means the smallest integer that is equal to or larger than log₂(K_{S}). Each of K CRIs or SSBRIs (e.g. CRI #1, CRI #2, . . . , CRI #K) has a value CRI k or SSBRI k (k is from 0 to K_{S}−1). CRI k or SSBRI k indicates the configured (k+1)^{th} entry of the NZP CSI-RS resources or SSB resources in the CMR set.

An L1-RSRP value or a differential L1-RSRP value of the resource indicated by each of K CRIs or SSBRIs is also included in the CSI report. To reduce the L1-RSRP report overhead, differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

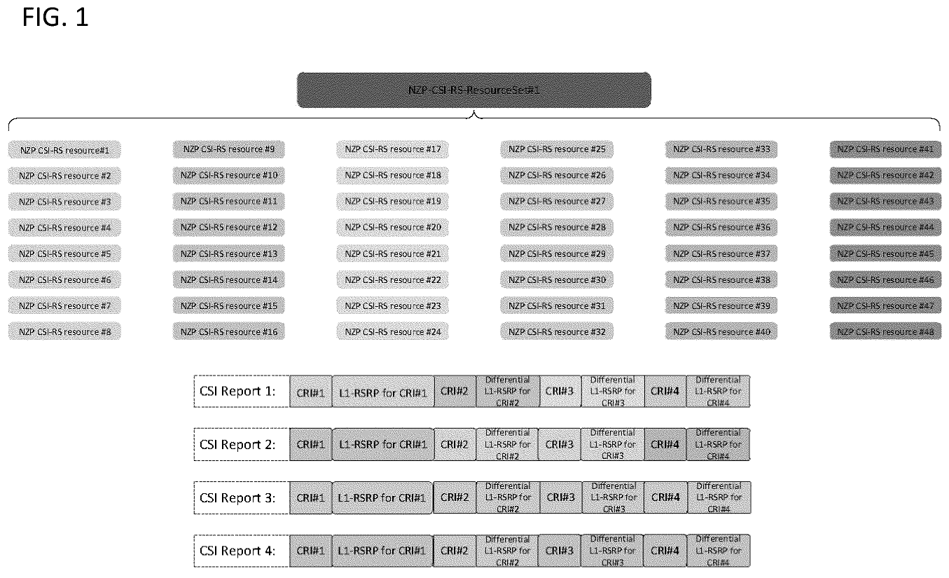

FIG. 1 illustrates an example of the resource setting and the CSI report according to the first sub-embodiment of the first embodiment.

In the example of FIG. 1, the higher layer parameter reportQuantity is set to ‘cri-RSRP’. Accordingly, the resource setting for channel measurement has one NZP CSI-RS resource set: NZP-CSI-RS-ResourceSet #1 consisting of for example 48 (i.e. K_{S}=48) NZP CSI-RS resources.

The higher layer parameter nrofReportedRS-Neighboring is set to 4 (i.e. K=4). Accordingly, the CSI report includes 4 CRIs (e.g. CRI #1, CRI #2, CRI #3 and CRI #4) and the L1-RSRP value or differential L1-RSRP values of resources indicated by the 4 CRIs.

Note that the measured L1-RSRP values of the NZP CSI-RS resources indicated by CRI #1, CRI #2, CRI #3 and CRI #4 are the four largest values among all measured L1-RSRP values of NZP CSI-RS resources #1 to #48, in which the measured L1-RSRP value of the NZP CSI-RS resource indicated by CRI #1 is the largest among the measured L1-RSRP values of the NZP CSI-RS resources indicated by CRI #1, CRI #2, CRI #3 and CRI #4.

The bit width of each of CRI #1, CRI #2, CRI #3 and CRI #4 is ┌log₂(48)┐=6 bits. The possible values of each of CRI #1, CRI #2, CRI #3 and CRI #4 are CRI 0, CRI 1, . . . , and CRI 47. CRI k (k is a value of any of 0 to 47) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

Four examples of CSI report (i.e. CSI Report 1, CSI Report 2, CSI Report 3 and CSI Report 4) are illustrated in FIG. 1.

In a second sub-embodiment of the first embodiment, one channel measurement resource (CMR) set is configured in a resource setting for channel measurement for a CSI report. Best K beams are reported in the CSI report, where each of the K beams (or every P beams of the K beams) is from a different non-serving cell.

The resource setting for channel measurement is associated with a CSI-ReportConfig IE, which configures a CSI Report and has a higher layer parameter reportQuantity (which configures the report contents in the CSI Report), and a higher layer parameter nrofReportedRS-Neighboring (which configures the number of reported beams of the non-serving cells in the CSI Report). The number of reported beams of the non-serving cells is denoted as K.

All the resources within the CMR set may be from or be associated with one or multiple non-serving cells. In some scenario, the gNB may want to know the qualities of multiple neighboring cells (non-serving cells). The quality of one non-serving cell can be represented by the best P (P can be 1 or more) beams having the largest measured L1-RSRP values of all measured L1-RSRP values of all beams of the one non-serving cell.

Therefore, according to the second sub-embodiment of the first embodiment, the one CMR set (also referred to as “the CMR set”) consists of multiple subsets, where each subset corresponds to one non-serving cell (i.e. all of resources within one subset are from or are associated with the same non-serving cell).

The subset can be determined by the UE in an implicit method. For example, all the resources associated with a same PCID (physical cell ID) are from one cell (e.g. one non-serving cell), and accordingly belong to the same subset. Each cell including serving cell and non-serving cell(s) is identified by a PCID.

The CMR set can be a CSI-SSB resource set (if the higher layer parameter reportQuantity is set to ‘ssb-Index-RSRP’) or an NZP CSI-RS resource set (if the higher layer parameter reportQuantity is set to ‘cri-RSRP’).

The number of subsets in the CMR set is denoted as S (S is 1 or more). Each subset corresponds to one non-serving cell. Therefore, S subsets correspond to S non-serving cells. The total number of resources within the CMR set is the sum of the number of resources within each subset, where the total number of resources within the CMR set is also denoted as K_{S}.

In the CSI Report according to the second sub-embodiment of the first embodiment, K largest measured L1-RSRP values and K CRIs or SSBRIs that indicate K NZP CSI-RS resources or SSB resources having the K largest measured L1-RSRP values are reported.

If S is equal to or larger than K, each of the K beams is from a different non-serving cell (i.e. each of K CRIs or SSBRIs indicates an NZP CSI-RS resource or a SSB resource that has the largest measured L1-RSRP value among the measured L1-RSRP values of the NZP CSI-RS resource or the SSB resource of a different subset).

If S is smaller than K, then K is configured as a multiple of S (e.g. P times of S, i.e. K=P*S). Every P beams of the K beams are from or be associated with a different non-serving cell. That is, every P CRIs or SSBRIs indicate P NZP CSI-RS resources or P SSB resources that have the P largest measured L1-RSRP values among the measured L1-RSRP values of the NZP CSI-RS resources or the SSB resources of a different subset.

The bit width of each of K CRIs or SSBRIs in the CSI report is determined by ┌log₂(K_{S})┐, which means the smallest integer that is equal to or larger than log₂(K_{S}). Each of K CRIs or SSBRIs (e.g. CRI #1, CRI #2, . . . , CRI #K) has a value CRI k or SSBRI k (k is from 0 to K_{S}−1). CRI k or SSBRI k indicates the configured (k+1)^{th} entry of the NZP CSI-RS resources or SSB resources in the CMR set.

An L1-RSRP value or a differential L1-RSRP value of the resource indicated by each of K CRIs or SSBRIs is also included in the CSI report. Differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

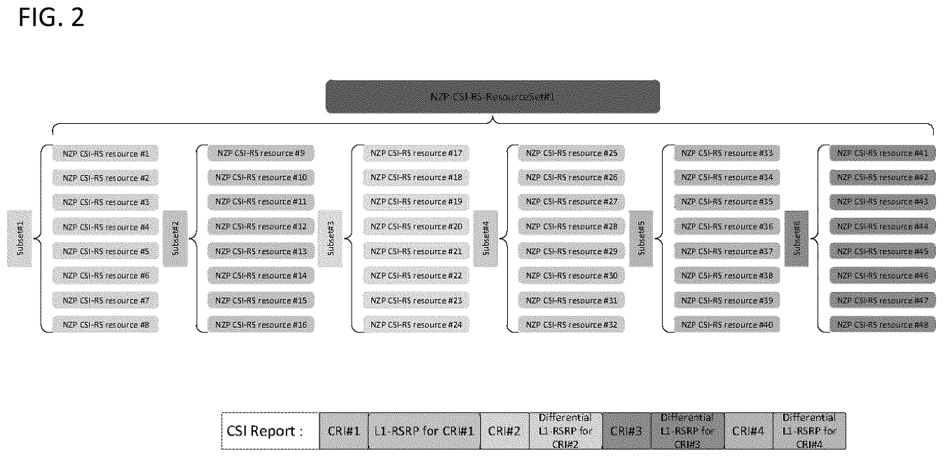

FIG. 2 illustrates an example of the resource setting and the CSI report according to the second sub-embodiment of the first embodiment, where S(=6) is larger than K (=4).

In the example of FIG. 2, the higher layer parameter reportQuantity is set to ‘cri-RSRP’. Accordingly, the resource setting for channel measurement has one NZP CSI-RS resource set: NZP-CSI-RS-ResourceSet #1. The NZP-CSI-RS-ResourceSet #1 consists of 6 (i.e. S=6) subsets:
Subset #1 consisting of 8 (i.e. M=8) NZP CSI-RS resources (#1 to #8) associated with e.g. PCID #1 corresponding to non-serving cell #1;
Subset #2 consisting of 8 NZP CSI-RS resources (#9 to #16) associated with e.g. PCID #2 corresponding to non-serving cell #2;
Subset #3 consisting of 8 NZP CSI-RS resources (#17 to #24) associated with e.g. PCID #3 corresponding to non-serving cell #3;
Subset #4 consisting of 8 NZP CSI-RS resources (#25 to #32) associated with e.g. PCID #4 corresponding to non-serving cell #4;
Subset #5 consisting of 8 NZP CSI-RS resources (#33 to #40) associated with e.g. PCID #5 corresponding to non-serving cell #5; and
Subset #6 consisting of 8 NZP CSI-RS resources (#41 to #48) associated with e.g. PCID #6 corresponding to non-serving cell #6.

Accordingly, K_{S}=S*M=6*8=48.

The higher layer parameter nrofReportedRS-Neighboring is set to 4 (i.e. K=4). Accordingly, the CSI report includes 4 CRIs (e.g. CRI #1, CRI #2, CRI #3 and CRI #4) and the L1-RSRP value or differential L1-RSRP values of resources indicated by the 4 CRIs.

Note that each of the measured L1-RSRP values of the NZP CSI-RS resources indicated by CRI #1, CRI #2, CRI #3 and CRI #4 is a largest L1-RSRP value of the measured L1-RSRP values of the NZP CSI-RS resources from a different subset (i.e. associated with a different PCID). In the example CSI report of FIG. 2,
CRI #1 indicates the NZP CSI-RS resource that has the largest measured L1-RSRP value of the measured L1-RSRP values of the NZP CSI-RS resources associated with PCID #2 (i.e. within subset #2, corresponding to non-serving cell #2);
CRI #2 indicates the NZP CSI-RS resource that has the largest measured L1-RSRP value of the measured L1-RSRP values of the NZP CSI-RS resources associated with PCID #1 (i.e. within subset #1, corresponding to non-serving cell #1);
CRI #3 indicates the NZP CSI-RS resource that has the largest measured L1-RSRP value of the measured L1-RSRP values of the NZP CSI-RS resources associated with PCID #6 (i.e. within subset #6, corresponding to non-serving cell #6); and
CRI #4 indicates the NZP CSI-RS resource that has the largest measured L1-RSRP value of the measured L1-RSRP values of the NZP CSI-RS resources associated with PCID #5 (i.e. within subset #5, corresponding to non-serving cell #5).

In particular, the measured L1-RSRP value of the NZP CSI-RS resource indicated by CRI #1 is the largest among all measured L1-RSRP values of the NZP CSI-RS resources indicated by CRI #1, CRI #2, CRI #3 and CRI #4.

The bit width of each of CRI #1, CRI #2, CRI #3 and CRI #4 is ┌log₂(48)┐=6 bits. The possible values of each of CRI #1, CRI #2, CRI #3 and CRI #4 are CRI 0, CRI 1, . . . , and CRI 47. CRI k (k is a value of any of 0 to 47) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

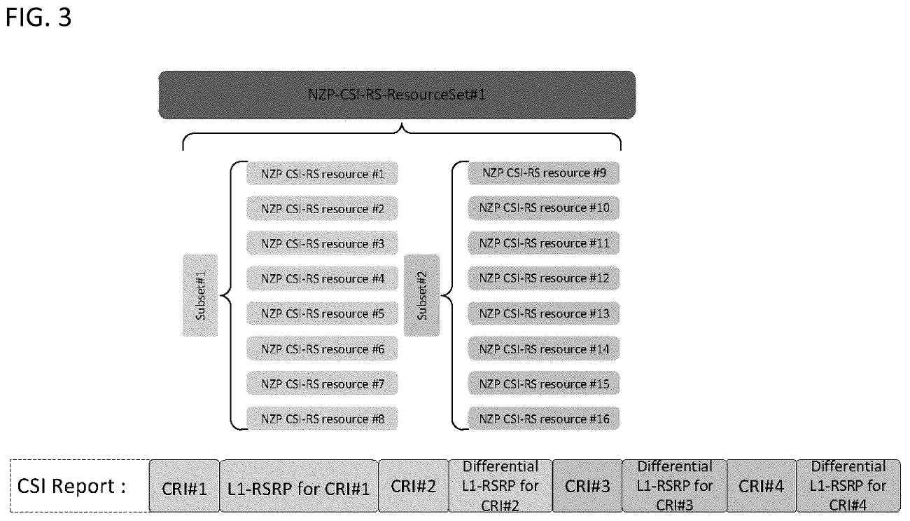

FIG. 3 illustrates another example of the resource setting and the CSI report according to the second sub-embodiment of the first embodiment, where S(=2) is smaller than K (=4).

In the example of FIG. 3, the higher layer parameter reportQuantity is set to ‘cri-RSRP’. Accordingly, the resource setting for channel measurement has one NZP CSI-RS resource set: NZP-CSI-RS-ResourceSet #1. The NZP-CSI-RS-ResourceSet #1 consists of 2 (i.e. S=2) subsets:
Subset #1 consisting of 8 (i.e. M=8) NZP CSI-RS resources (#1 to #8) associated with e.g. PCID #1 corresponding to non-serving cell #1; and
Subset #2 consisting of 8 NZP CSI-RS resources (#9 to #16) associated with e.g. PCID #2 corresponding to non-serving cell #2.

Accordingly, K_{S}=S*M=2*8=16.

The higher layer parameter nrofReportedRS-Neighboring is set to 4 (i.e. K=4). K=P*S=2*2. Accordingly, the CSI report includes 4 CRIs (e.g. CRI #1, CRI #2, CRI #3 and CRI #4) and the L1-RSRP value or differential L1-RSRP values of resources indicated by the 4 CRIs.

Note that 2 (i.e. P=2) of the measured L1-RSRP values of the NZP CSI-RS resources indicated by CRI #1, CRI #2, CRI #3 and CRI #4 (e.g. indicated by CRI #1 and CRI #2 in FIG. 3) are 2 largest L1-RSRP values (i.e. the largest L1-RSRP value and the second largest L1-RSRP value) of the measured L1-RSRP values of the NZP CSI-RS resources of Subset #1 (i.e. associated with PCID #1, corresponding to non-serving cell #1), and the other 2 of the measured L1-RSRP values of the NZP CSI-RS resources indicated by CRI #1, CRI #2, CRI #3 and CRI #4 (e.g. indicated by CRI #3 and CRI #4 in FIG. 3) are 2 largest L1-RSRP values (i.e. the largest L1-RSRP value and the second largest L1-RSRP value) of the measured L1-RSRP values of the NZP CSI-RS resources of Subset #2 (i.e. associated with PCID #2, corresponding to non-serving cell #2). In particular, the measured L1-RSRP value of the NZP CSI-RS resource indicated by CRI #1 is the largest among all measured L1-RSRP values of the NZP CSI-RS resources indicated by CRI #1, CRI #2, CRI #3 and CRI #4.

The bit width of each of CRI #1, CRI #2, CRI #3 and CRI #4 is ┌log₂(16)┐=4 bits. The possible values of each of CRI #1, CRI #2, CRI #3 and CRI #4 are CRI 0, CRI 1, . . . , and CRI 15. CRI k (k is a value of any of 0 to 15) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

In a third sub-embodiment of the first embodiment, multiple channel measurement resource (CMR) sets are configured in a resource setting for channel measurement for a CSI report. Best K beams and the corresponding measured L1-RSRP values are reported in the CSI report.

The resource setting for channel measurement is associated with a CSI-ReportConfig IE, which configures a CSI Report and has a higher layer parameter reportQuantity (which configures the report contents in the CSI Report), and a higher layer parameter nrofReportedRS-Neighboring (which configures the number of reported beams of the non-serving cells in the CSI Report). The number of reported beams of the non-serving cells is denoted as K.

Each of the multiple CMR sets can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’). Each CMR set consists of NZP CSI-RS resources or SSB resources from a different non-serving cell.

The number of CMR sets is denoted as C_{S}, where the CMR set ID is from 0 to C_{S}−1. The number of resources (NZP CSI-RS resources or SSB resources) contained in each CMR set is denoted as K_{S}, where the resource ID within each CMR set is from 1 to K_{S}.

In the CSI Report according to the third sub-embodiment of the first embodiment, K largest measured L1-RSRP values and K CRIs or SSBRIs that indicate K NZP CSI-RS resources or SSB resources having the K largest measured L1-RSRP values are reported.

Because each of K CRIs or SSBRIs may indicate an NZP CSI-RS resource or SSB resource from any of the multiple CMR sets, it is necessary to indicate the CMR set from which each of K CRIs or SSBRIs indicates the NZP CSI-RS resources or SSB resources. A CSI-RS resource set indicator (CRSI) or a SSB resource set indicator (SSBRSI) is included as CMR set ID to indicate the CMR set. Each of K CRSIs or SSBRSIs can indicate the same CMR set or different CMR sets, or some of K CRSIs or SSBRSIs indicate the same CMR set while some others of K CRSIs or SSBRSIs indicate different CMR set(s).

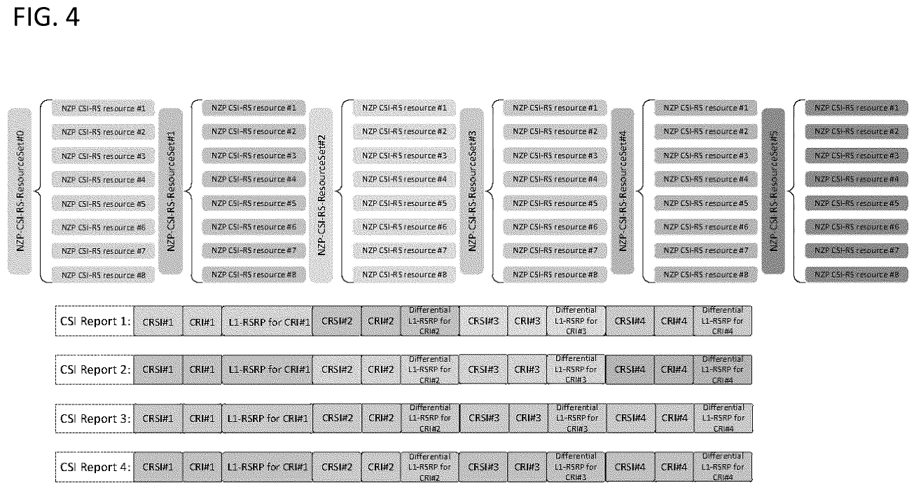

The bit width of each of K CRSIs or SSBRSIs in the CSI report is determined by ┌log₂(C_{S})┐, which means the smallest integer that is equal to or larger than log₂(C_{S}). Each of K CRSIs or SSBRSIs (e.g. CRSI #1, CRSI #2, . . . , CRSI #K) has a value CRSI k or SSBRSI k (k is from 0 to C_{S}−1). CRSI k or SSBRSI k indicates the (k+1)^{th} CMR set. For example, CRSI 0 indicates the first CMR set (i.e. CMR set 0, e.g. NZP-CSI-RS-ResourceSet #0 as shown in FIG. 4).

The bit width of each of K CRIs or SSBRIs in the CSI report is determined by ┌log₂(K_{S})┐, which means the smallest integer that is equal to or larger than log₂(K_{S}). Each of K CRIs or SSBRIs (e.g. CRI #1, CRI #2, . . . , CRI #K) has a value CRI k or SSBRI k (k is from 0 to K_{S}−1). CRI k or SSBRI k indicates the configured (k+1)^{th} entry of the NZP CSI-RS resources or SSB resources in each CMR set.

An L1-RSRP value or a differential L1-RSRP value of the resource indicated by each of K CRIs or SSBRIs is also included in the CSI report. To reduce the L1-RSRP report overhead, differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

FIG. 4 illustrates an example of the resource setting and the CSI report according to the third sub-embodiment of the first embodiment.

In the example of FIG. 4, the higher layer parameter reportQuantity is set to ‘cri-RSRP’. Accordingly, the resource setting for channel measurement has e.g. 6 (C_{S}=6) NZP CSI-RS resource sets: NZP-CSI-RS-ResourceSet #0 to NZP-CSI-RS-ResourceSet #5, each consisting of for example 8 (i.e. K_{S}=8) NZP CSI-RS resources (NZP CSI-RS resource #1 to NZP CSI-RS resource #8).

The higher layer parameter nrofReportedRS-Neighboring is set to 4 (i.e. K=4). Accordingly, the CSI report includes 4 CRSIs (e.g. CRSI #1, CRSI #2, CRSI #3 and CRSI #4), 4 CRIs (e.g. CRI #1, CRI #2, CRI #3 and CRI #4) and the L1-RSRP value or differential L1-RSRP values of resources indicated by the 4 CRIs.

Note that the measured L1-RSRP values of the NZP CSI-RS resources indicated by CRI #1, CRI #2, CRI #3 and CRI #4 are the four largest values among all measured L1-RSRP values of NZP CSI-RS resources of all CMR sets, in which the measured L1-RSRP value of the NZP CSI-RS resource indicated by CRI #1 is the largest among the measured L1-RSRP values of the NZP CSI-RS resources indicated by CRI #1, CRI #2, CRI #3 and CRI #4.

The bit width of each of CRSI #1, CRSI #2, CRSI #3 and CRSI #4 is ┌log₂(6)┐=3 bits. The possible values of each of CRSI #1, CRSI #2, CRSI #3 and CRSI #4 are CRSI 0, CRSI 1, . . . , and CRSI 5. CRSI k (k is a value of any of 0 to 5) indicates NZP-CSI-RS-ResourceSet #k.

The bit width of each of CRI #1. CRI #2, CRI #3 and CRI #4 is ┌log₂(8)┐=3 bits. The possible values of each of CRI #1, CRI #2, CRI #3 and CRI #4 are CRI 0, CRI 1, . . . , and CRI 7. CRI k (k is a value of any of 0 to 7) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

FIG. 4 illustrates four examples of the CSI report (CSI Report 1, CSI Report 2, CSI Report 3 and CSI Report 4). In CSI Report 1, CRSI #1, CRSI #2, CRSI #3 and CRSI #4 indicate different NZP CSI-RS resource sets, i.e. NZP-CSI-RS-ResourceSet #0, NZP-CSI-RS-ResourceSet #1. NZP-CSI-RS-ResourceSet #2 and NZP-CSI-RS-ResourceSct #3, respectively. In CSI Report 2, CRSI #1, CRSI #2, CRSI #3 and CRSI #4 indicate NZP-CSI-RS-ResourceSet #1, NZP-CSI-RS-ResourceSet #0, NZP-CSI-RS-ResourceSet #0 and NZP-CSI-RS-ResourceSet #4, respectively (i.e. some indicates the same NZP-CSI-RS-ResourceSet (NZP-CSI-RS-ResourceSet #0), some other indicate different NZP-CSI-RS-ResourceSet (NZP-CSI-RS-ResourceSet #1 or NZP-CSI-RS-ResourceSet #4)). In CSI Report 3, CRSI #1, CRSI #2, CRSI #3 and CRSI #4 indicate the same subset, i.e. NZP-CSI-RS-ResourceSet #3. In CSI Report 4, CRSI #1, CRSI #2, CRSI #3 and CRSI #4 indicate NZP-CSI-RS-ResourceSet #1, NZP-CSI-RS-ResourceSet #3, NZP-CSI-RS-ResourceSet #1 and NZP-CSI-RS-ResourceSet #1, respectively (i.e. some indicates the same NZP-CSI-RS-ResourceSet (NZP-CSI-RS-ResourceSet #1), some other indicates a different NZP-CSI-RS-ResourceSet (NZP-CSI-RS-ResourceSet #3).

In a fourth sub-embodiment of the first embodiment, multiple channel measurement resource (CMR) sets are configured in a resource setting for channel measurement for a CSI report. Best K beams are reported in the CSI report, where each of the K beams (or every P beams of the K beams) is from a different non-serving cell.

The resource setting for channel measurement is associated with a CSI-ReportConfig IE, which configures a CSI Report and has a higher layer parameter reportQuantity (which configures the report contents in the CSI Report), and a higher layer parameter nrofReportedRS-Neighboring (which configures the number of reported beams of the non-serving cells in the CSI Report). The number of reported beams of the non-serving cells is denoted as K.

Each of the multiple CMR sets can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’). Each CMR set consists of NZP CSI-RS resources or SSB resources from a different non-serving cell.

The number of CMR sets is denoted as C_{S}, where the CMR set ID is from 0 to C_{S}−1. The number of resources (NZP CSI-RS resources or SSB resources) contained in each CMD set is denoted as K_{S}, where the resource ID is from 1 to K_{S}.

In the CSI Report according to the fourth sub-embodiment of the first embodiment, K largest measured L1-RSRP values and K CRIs or SSBRIs that indicate K NZP CSI-RS resources or SSB resources having the K largest measured L1-RSRP values are reported.

If C_{S} is equal to or larger than K, each of the K beams is from a different non-serving cell (i.e. each of K CRIs or SSBRIs indicates an NZP CSI-RS resource or a SSB resource that has the largest measured L1-RSRP value among the measured L1-RSRP values of the NZP CSI-RS resource or the SSB resource of a different CMR set).

If C_{S} is smaller than K, then K is configured as a multiple of C_{S} (e.g. P times of C_{S}. i.e. K=P*C_{S}). Every P beams of the K beams are from a different non-serving cell. That is, every P CRIs or SSBRIs indicate P NZP CSI-RS resources or P SSB resources that have the P largest measured L1-RSRP values among the measured L1-RSRP values of the NZP CSI-RS resources or the SSB resources of a different CMR set.

Because each of K CRIs or SSBRIs may indicate an NZP CSI-RS resource or SSB resource from different CMR sets, it is necessary to indicate the CMR set from which each of K CRIs or SSBRIs indicates the NZP CSI-RS resources or SSB resource. A CSI-RS resource set indicator (CRSI) or a SSB resource set indicator (SSBRSI) is included as CMR set ID to indicate the CMR set. Each of K CRSIs or SSBRSIs can indicate the same CMR set or different CMR sets, or some of K CRSIs or SSBRSIs indicate the same CMR set while some others of K CRSIs or SSBRSIs indicate different CMR sets.

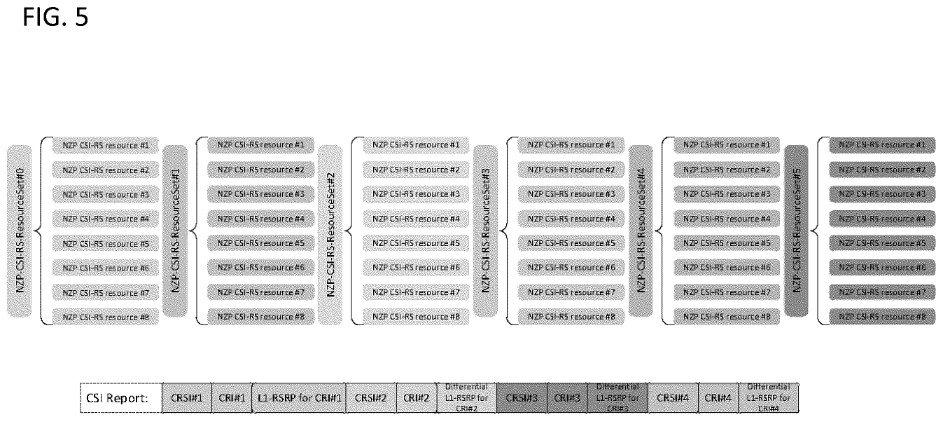

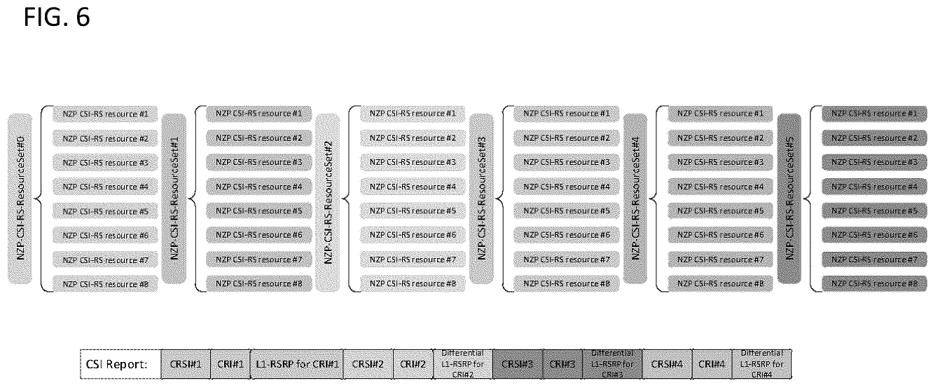

The bit width of each of K CRSIs or SSBRSIs in the CSI report is determined by ┌log₂(C_{S})┐, which means the smallest integer that is equal to or larger than log₂(C_{S}). Each of K CRSIs or SSBRSIs (e.g. CRSI #1, CRSI #2, . . . , CRSI #K) has a value CRSI k or SSBRSI k (k is from 0 to C_{S}−1). CRSI k or SSBRSI k indicates the (k+1)^{th} CMR set. For example, CRSI 0 indicates the first CMR set (i.e. CMR set 0, e.g. NZP-CSI-RS-ResourceSet #0 shown in FIG. 5 or 6).

The bit width of each of K CRIs or SSBRIs in the CSI report is determined by ┌log₂(K_{S})┐, which means the smallest integer that is equal to or larger than log₂(K_{S}). Each of K CRIs or SSBRIs (e.g. CRI #1, CRI #2, . . . , CRI #K) has a value CRI k or SSBRI k (k is from 0 to K_{S}−1). CRI k or SSBRI k indicates the configured (k+1)^{th} entry of the NZP CSI-RS resources or SSB resources in each CMR set.

An L1-RSRP value or a differential L1-RSRP value of the resource indicated by each of K CRIs or SSBRIs is also included in the CSI report. Differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

FIG. 5 illustrates an example of the resource setting and the CSI report according to the fourth sub-embodiment of the first embodiment, where C_{S} (=6) is larger than K (=4).

In the example of FIG. 5, the higher layer parameter reportQuantity is set to ‘cri-RSRP’. Accordingly, the resource setting for channel measurement has e.g. 6 (C_{S}=6) NZP CSI-RS resource sets: NZP-CSI-RS-ResourceSet #0 to NZP-CSI-RS-ResourceSet #5, each consisting of for example 8 (i.e. K_{S}=8) NZP CSI-RS resources (NZP CSI-RS resource #1 to NZP CSI-RS resource #8).

The higher layer parameter nrofReportedRS-Neighboring is set to 4 (i.e. K=4). Accordingly, the CSI report includes 4 CRSIs (e.g. CRSI #1, CRSI #2, CRSI #3 and CRSI #4), 4 CRIs (e.g. CRI #1, CRI #2, CRI #3 and CRI #4) and the L1-RSRP value or differential L1-RSRP values of resources indicated by the 4 CRIs.

Note that each of the measured L1-RSRP values of the NZP CSI-RS resources indicated by CRI #1, CRI #2, CRI #3 and CRI #4 is a largest L1-RSRP value of the measured L1-RSRP values of the NZP CSI-RS resources from a different CMR set. In the example of FIG. 5,
CRI #1 indicates the NZP CSI-RS resource that has the largest measured L1-RSRP value of the measured L1-RSRP values of the NZP CSI-RS resources in CMR set #3 (i.e. NZP-CSI-RS-ResourceSet #3);
CRI #2 indicates the NZP CSI-RS resource that has the largest measured L1-RSRP value of the measured L1-RSRP values of the NZP CSI-RS resources in CMR set #0 (i.e. NZP-CSI-RS-ResourceSet #0);
CRI #3 indicates the NZP CSI-RS resource that has the largest measured L1-RSRP value of the measured L1-RSRP values of the NZP CSI-RS resources in CMR set #5 (i.e. NZP-CSI-RS-ResourceSet #5); and
CRI #4 indicates the NZP CSI-RS resource that has the largest measured L1-RSRP value of the measured L1-RSRP values of the NZP CSI-RS resources in CMR set #1 (i.e. NZP-CSI-RS-ResourceSet #1).

In particular, the measured L1-RSRP value of the NZP CSI-RS resource indicated by CRI #1 is the largest among all measured L1-RSRP values of the NZP CSI-RS resources indicated by CRI #1, CRI #2, CRI #3 and CRI #4.

The bit width of each of CRSI #1, CRSI #2, CRSI #3 and CRSI #4 is ┌log₂(6)┐=3 bits. The possible values of each of CRSI #1, CRSI #2, CRSI #3 and CRSI #4 are CRSI 0, CRSI 1, . . . , and CRSI 5. CRSI k (k is a value of any of 0 to 5) indicates NZP-CSI-RS-ResourceSet #k.

The bit width of each of CRI #1, CRI #2, CRI #3 and CRI #4 is ┌log₂(8)┐=3 bits. The possible values of each of CRI #1, CRI #2, CRI #3 and CRI #4 are CRI 0, CRI 1, . . . , and CRI 7. CRI k (k is a value of any of 0 to 7) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

FIG. 6 illustrates another example of the resource setting and the CSI report according to the fourth sub-embodiment of the first embodiment, where C_{S} (=2) is smaller than K (=4).

In the example of FIG. 6, the higher layer parameter reportQuantity is set to ‘cri-RSRP’. Accordingly, the resource setting for channel measurement has e.g. 2 (C_{S}=2) NZP CSI-RS resource sets: NZP-CSI-RS-ResourceSet #0 to NZP-CSI-RS-ResourceSet #1, each consisting of for example 8 (i.e. K_{S}=8) NZP CSI-RS resources (NZP CSI-RS resource #1 to NZP CSI-RS resource #8).

The higher layer parameter nrofReportedRS-Neighboring is set to 4 (i.e. K=4). K=P*C_{S}=2*2. Accordingly, the CSI report includes 4 CRSIs (e.g. CRSI #1, CRSI #2, CRSI #3 and CRSI #4), 4 CRIs (e.g. CRI #1, CRI #2, CRI #3 and CRI #4) and the L1-RSRP value or differential L1-RSRP values of resources indicated by the 4 CRIs.

Note that 2 (i.e. P=2) of the measured L1-RSRP values of the NZP CSI-RS resources indicated by CRI #1, CRI #2, CRI #3 and CRI #4 (e.g. indicated by CRI #1 and CRI #2 in FIG. 6) are 2 largest measured L1-RSRP values (i.e. the largest L1-RSRP value and the second largest L1-RSRP value) of the measured L1-RSRP values of the NZP CSI-RS resources from NZP-CSI-RS-ResourceSet #0, and the other 2 of the L1-RSRP values of the NZP CSI-RS resources indicated by CRI #1, CRI #2, CRI #3 and CRI #4 (e.g. indicated by CRI #3 and CRI #4 in FIG. 6) are 2 largest measured L1-RSRP values (i.e. the largest L1-RSRP value and the second largest L1-RSRP value) of the measured L1-RSRP values of the NZP CSI-RS resources from NZP-CSI-RS-ResourceSet #1. In particular, the measured L1-RSRP value of the NZP CSI-RS resource indicated by CRI #1 is the largest among all measured L1-RSRP values of the NZP CSI-RS resources indicated by CRI #1, CRI #2, CRI #3 and CRI #4.

The bit width of each of CRSI #1, CRSI #2, CRSI #3 and CRSI #4 is ┌log₂(2)┐=1 bit. The possible values of each of CRSI #1, CRSI #2, CRSI #3 and CRSI #4 are CRSI 0 or CRSI 1. CRSI k (k is a value of any of 0 to 1) indicates NZP-CSI-RS-ResourceSet #k.

The bit width of each of CRI #1, CRI #2, CRI #3 and CRI #4 is ┌log₂(8)┐=3 bits. The possible values of each of CRI #1, CRI #2, CRI #3 and CRI #4 are CRI 0, CRI 1, . . . , and CRI 7. CRI k (k is a value of any of 0 to 7) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

According to a second embodiment, one CSI report contains beam report for serving cell as well as beam report for non-serving cell(s). The resource setting for channel measurement contains resources from both the serving cell and the non-serving cell(s).

In a first sub-embodiment of the second embodiment, one channel measurement resource (CMR) set is configured in a resource setting for channel measurement for a CSI report. Best K beams are reported in the CSI report. The best K beams are all from the serving cell or all from the non-serving cells or from both serving cell and non-serving cell.

The resource setting for channel measurement is associated with a CSI-ReportConfig IE, which configures a CSI Report and has a higher layer parameter reportQuantity (which configures the report contents in the CSI Report), and a higher layer parameter nrofReportedRS-Neighboring (which configures the number of reported beams of the non-serving cells in the CSI Report), and/or a higher layer parameter nrofReportedRS (which configures the number of reported beams of the serving cell in the CSI Report). The number of reported beams of the non-serving cells, if configured, is denoted as K. The number of reported beams of the serving cell, if configured, is denoted as N.

The one CMR set (also referred to as “the CMR set”) can be a CSI-SSB resource set consisting of SSB resources from the serving cell and/or the non-serving cell(s) (if the higher layer parameter reportQuantity is set to ‘ssb-Index-RSRP’) or an NZP CSI-RS resource set consisting of NZP CSI-RS resources QCLed and associated with SSB resources from the serving cell and/or the non-serving cell(s) (if the higher layer parameter reportQuantity is set to ‘cri-RSRP’). All of the SSB resources or NZP CSI-RS resources may be from or be associated with both the serving cell and one or multiple non-serving cells. All the resources (SSB resources or NZP CSI-RS resources) are associated with a PCID (physical cell ID). The resources may be associated with the PCID of the serving cell, or associated with any of the PCIDs of the non-serving cells.

The number of CMR resources (i.e. SSB resources or NZP CSI-RS resources) is denoted as K_{S}.

If the higher layer parameter nrofReportedRS is configured while the higher layer parameter nrofReportedRS-Neighboring is not configured, the CSI report includes N largest measured L1-RSRP values of the SSB resources or NZP CSI-RS resources associated with the PCID of the serving cell.

If the higher layer parameter nrofReportedRS is not configured while the higher layer parameter nrofReportedRS-Neighboring is configured, the CSI report includes K largest measured L1-RSRP values of the SSB resources or NZP CSI-RS resources associated with any of the PCIDs of the non-serving cells.

In the CSI Report according to the first sub-embodiment of the second embodiment, K largest measured L1-RSRP values and K CRIs or SSBRIs that indicate K NZP CSI-RS resources or SSB resources associated with or from non-serving cell(s) having the K largest measured L1-RSRP values are reported.

The bit width of each of K CRIs or SSBRIs in the CSI report is determined by ┌log₂(K_{S})┐, which means the smallest integer that is equal to or larger than log₂(K_{S}). Each of K CRIs or SSBRIs (e.g. CRI #1, CRI #2, . . . . CRI #K) has a value CRI k or SSBRI k (k is from 0 to K_{S}−1). CRI k or SSBRI k indicates the configured (k+1)^{th} entry of the NZP CSI-RS resources or SSB resources in the CMR set.

An L1-RSRP value or a differential L1-RSRP value of the resource indicated by each of K CRIs or SSBRIs is also included in the CSI report. To reduce the L1-RSRP report overhead, differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

The example of the resource setting and the CSI report according to the first sub-embodiment of the second embodiment can be also described with reference to FIG. 1.

In the example of FIG. 1, the higher layer parameter reportQuantity is set to ‘cri-RSRP’. Accordingly, the resource setting for channel measurement has one NZP CSI-RS resource set: NZP-CSI-RS-ResourceSet #1 consisting of for example 48 (i.e. K_{S}=48) NZP CSI-RS resources. Suppose that NZP CSI-RS resources #1 to #40 are associated with any of the PCIDs of the non-serving cells, while NZP CSI-RS resources #41 to #48 are associated with the PCID of the serving cell.

The higher layer parameter nrofReportedRS-Neighboring is set to 4 (i.e. K=4), while the higher layer parameter nrofReportedRS is not configured. Accordingly, the CSI report includes 4 CRIs (e.g. CRI #1, CRI #2, CRI #3 and CRI #4) and the L1-RSRP value or differential L1-RSRP values of resources indicated by the 4 CRIs.

Note that the measured L1-RSRP values of the NZP CSI-RS resources indicated by CRI #1, CRI #2, CRI #3 and CRI #4 are the four largest values among all measured L1-RSRP values of NZP CSI-RS resources #1 to #40 (i.e. the NZP CSI-RS resources associated with any of the PCIDs of the non-serving cells), in which the measured L1-RSRP value of the NZP CSI-RS resource indicated by CRI #1 is the largest among the measured L1-RSRP values of the NZP CSI-RS resources indicated by CRI #1, CRI #2, CRI #3 and CRI #4.

The bit width of each of CRI #1, CRI #2, CRI #3 and CRI #4 is ┌log₂(48)┐=6 bits. The possible values of each of CRI #1, CRI #2, CRI #3 and CRI #4 are CRI 0, CRI 1, . . . , and CRI 39. CRI k (k is a value of any of 0 to 39) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3 and CRI #4 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3 and CRI #4 in the CSI Report has a bit length of 4 bits.

Four examples of CSI report (i.e. CSI Report 1, CSI Report 2, CSI Report 3 and CSI Report 4) are illustrated in FIG. 1.

In a second sub-embodiment of the second embodiment, one channel measurement resource (CMR) set is configured in a resource setting for channel measurement for a CSI report. Best K beams from the non-serving cells and best N beams from the serving cell are reported in the CSI report.

The resource setting for channel measurement is associated with a CSI-ReportConfig IE, which configures a CSI Report and has a higher layer parameter reportQuantity (which configures the report contents in the CSI Report), a higher layer parameter nrofReportedRS (which configures the number of reported beams of the serving cell in the CSI Report) and a higher layer parameter nrofReportedRS-Neighboring (which configures the number of reported beams of the non-serving cells in the CSI Report). In the present disclosure, the number of reported beams of the serving cell is denoted as N, and the number of reported beams of the non-serving cells is denoted as K.

The one CMR set (also referred to as “the CMR set”) can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’).

The CMR set consists of two subsets, where one subset (e.g. a first subset) consists of resources associated with the PCID of the serving cell, and the other subset (e.g. a second subset) consists of resources associated with any of the PCIDs of the non-serving cells. The number of CMR resources (i.e. SSB resources or NZP CSI-RS resources) within the CMR set (or within two subsets of the CMR set) is denoted as K_{S}.

In the CSI Report according to the second sub-embodiment of the second embodiment, K largest measured L1-RSRP values of K NZP CSI-RS resources or SSB resources associated with any of the PCIDs of the non-serving cells and K CRIs or SSBRIs that indicate the K NZP CSI-RS resources or SSB resources, and N largest measured L1-RSRP values of N NZP CSI-RS resources or SSB resources associated with the PCID of the serving cell and N CRIs or SSBRIs that indicate the N NZP CSI-RS resources or SSB resources are reported.

The bit width of each of N and K CRIs or SSBRIs in the CSI report is determined by ┌log₂(K_{S})┐, which means the smallest integer that is equal to or larger than log₂(K_{S}). Each of N and K CRIs or SSBRIs (e.g. CRI #1, CRI #2, . . . , CRI #K+N) has a value CRI k or SSBRI k (k is from 0 to K_{S}−1). CRI k or SSBRI k indicates the configured (k+1)^{th} entry of the NZP CSI-RS resources or SSB resources in the CMR set.

An L1-RSRP value or a differential L1-RSRP value of the resource indicated by each of K CRIs or SSBRIs is also included in the CSI report. To reduce the L1-RSRP report overhead, differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

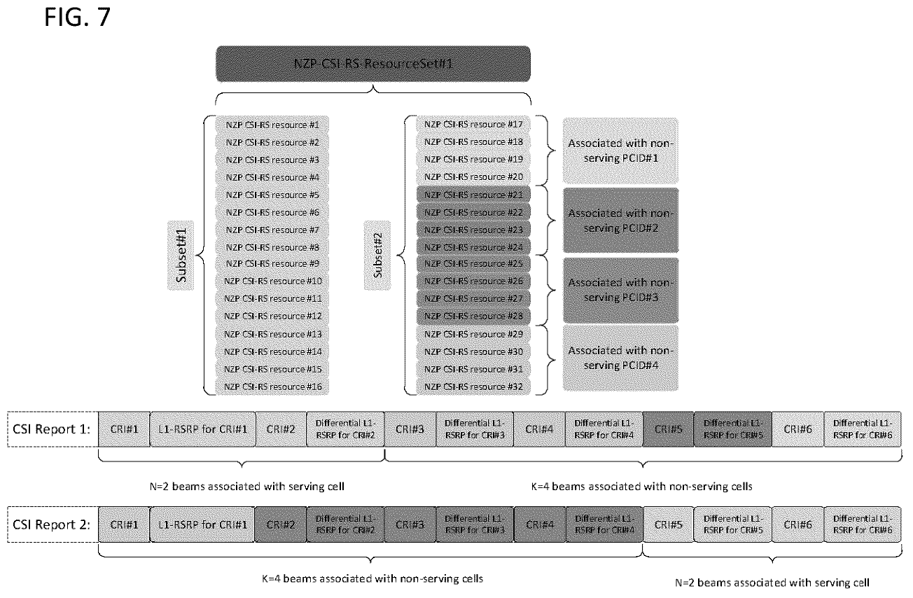

FIG. 7 illustrates an example of the resource setting and the CSI report according to the second sub-embodiment of the second embodiment.

In the example of FIG. 7, the higher layer parameter reportQuantity is set to ‘cri-RSRP’. Accordingly, the resource setting for channel measurement has one NZP CSI-RS resource set: NZP-CSI-RS-ResourceSet #1 consisting of two subsets: Subset #1 consists of NZP CSI-RS resources #1 to #16 associated with the PCID of the serving cell; and Subset #2 consists of NZP CSI-RS resources #17 to #32, in which NZP CSI-RS resources #17 to #20 are associated with the non-serving PCID #1, NZP CSI-RS resources #21 to #24 are associated with the non-serving PCID #2, NZP CSI-RS resources #25 to #28 are associated with the non-serving PCID #3, NZP CSI-RS resources #29 to #32 are associated with the non-serving PCID #4. As a whole, the NZP CSI-RS resource set consists of 32 NZP CSI-RS resources (i.e. K_{S}=32).

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP value or differential L1-RSRP values of resources indicated by the 6 CRIs, in which 2 of the 6 CRIs (e.g. CRI #1 and CRI #2 in CSI Report 1, or CRI #5 and CRI #6 in CSI Report 2) indicate NZP CSI-RS resources of Subset #1 associated with the PCID of the serving cell, and the other 4 of the 6 CRIs (e.g. CRI #3, CRI #4, CRI #5 and CRI #6 in CSI Report 1, or CRI #1, CRI #2, CRI #3 and CRI #4 in CSI Report 2) indicate NZP CSI-RS resources of Subset #2 associated with any of PCID #1, PCID #2, PCID #3 and PCID #4.

Two examples of CSI report (i.e. CSI Report 1 and CSI Report 2) are illustrated in FIG. 7.

In CSI Report 1, the measured L1-RSRP values of the NZP CSI-RS resources indicated by CRI #1 and CRI #2 are the two largest (i.e. the largest and the second largest) values among all measured L1-RSRP values of NZP CSI-RS resources #1 to #16 in Subset #1, and the measured L1-RSRP values of the NZP CSI-RS resources indicated by CRI #3, CRI #4, CRI #5 and CRI #6 (that are associated with PCID #4, PCID #4, PCID #2 and PCID #1, respectively) are the four largest values among all measured L1-RSRP values of NZP CSI-RS resources #17 to #32 in Subset #2, in which the measured L1-RSRP value of the NZP CSI-RS resource indicated by CRI #1 is the largest among the measured L1-RSRP values of the NZP CSI-RS resources indicated by CRI #1 to CRI #6.

In CSI Report 2, the measured L1-RSRP values of the NZP CSI-RS resources indicated by CRI #1, CRI #2, CRI #3 and CRI #4 (that are associated with PCID #4, PCID #2, PCID #2 and PCID #2, respectively) are the four largest values among all measured L1-RSRP values of NZP CSI-RS resources #17 to #32 in Subset #2, and the measured L1-RSRP values of the NZP CSI-RS resources indicated by CRI #5 and CRI #6 are the two largest values among all measured L1-RSRP values of NZP CSI-RS resources #1 to #16 in Subset #1, in which the measured L1-RSRP value of the NZP CSI-RS resource indicated by CRI #1 is the largest among the measured L1-RSRP values of the NZP CSI-RS resources indicated by CRI #1 to CRI #6.

The bit width of each of CRI #1, CRI #2, CRI #3, CRI #4, CRI #5 and CRI #6 is ┌log₂(32)┐=5 bits. For CSI Report 1, the possible values of each of CRI #1 and CRI #2 are CRI 0, CRI 1, . . . , and CRI 15; and the possible values of each of CRI #3, CRI #4, CRI #5 and CRI #6 are CRI 16, CRI 17, . . . , and CRI 31. For CSI Report 2, the possible values of each of CRI #1, CRI #2, CRI #3 and CRI #4 are CRI 16, CRI 17, . . . , and CRI 31; and the possible values of each of CRI #5 and CRI #6 are CRI 0, CRI 1, . . . , and CRI 15. CRI k (k is a value of any of 0 to 31) indicates NZP CSI-RS resource #(k+1).

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report has a bit length of 4 bits.

In a third sub-embodiment of the second embodiment, one channel measurement resource (CMR) set is configured in a resource setting for channel measurement for a CSI report. Best K beams from the non-serving cells and best N beams from the serving cell are reported in the CSI report, where each of the K beams (or every P beams of the K beams) is from a different non-serving cell.

The resource setting for channel measurement is associated with a CSI-ReportConfig IE, which configures a CSI Report and has a higher layer parameter reportQuantity (which configures the report contents in the CSI Report), a higher layer parameter nrofReportedRS (which configures the number of reported beams of the serving cell in the CSI Report) and a higher layer parameter nrofReportedRS-Neighboring (which configures the number of reported beams of the non-serving cells in the CSI Report). The number of reported beams of the serving cell is denoted as N, and the number of reported beams of the non-serving cells is denoted as K.

All the resources within the CMR set may be from or be associated with the serving cell and one or multiple non-serving cells. In some scenario, the gNB may want to know the qualities of both the serving cell and some neighboring cells (non-serving cells).

The one CMR set (also referred to as “the CMR set”) can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’).

The CMR set consists of two subsets, where one subset (e.g. a first subset) consists of resources associated with the PCID of the serving cell, and the other subset (e.g. a second subset) consists of resources associated with any of the PCIDs of the non-serving cells. The number of PCIDs of the non-serving cells is denoted as D_{S} (D_{S} is 1 or more). The number of CMR resources (i.e. SSB resources or NZP CSI-RS resources) within the CMR set (or within two subsets of the CMR set) is denoted as K_{S}.

In the CSI Report according to the third sub-embodiment of the second embodiment, K largest measured L1-RSRP values of K NZP CSI-RS resources or SSB resources associated with the PCIDs of the non-serving cells and K CRIs or SSBRIs that indicate the K NZP CSI-RS resources or SSB resources, and N largest measured L1-RSRP values of N NZP CSI-RS resources or SSB resources associated with the PCID of the serving cell and N CRIs or SSBRIs that indicate the N NZP CSI-RS resources or SSB resources are reported.

If D_{S} is equal to or larger than K, each of the K NZP CSI-RS resources or SSB resources associated with the PCIDs of the non-serving cells is associated with a different PCID.

If D_{S} is smaller than K, then K is configured as a multiple of D_{S} (e.g. P times of D_{S}, i.e., K=P*D_{S}. Every P NZP CSI-RS resources or SSB resources of the K NZP CSI-RS resources or SSB resources associated with the PCIDs of the non-serving cells are associated with a different PCID.

The bit width of each of N and K CRIs or SSBRIs in the CSI report is determined by ┌log₂(K_{S})┐, which means the smallest integer that is equal to or larger than log₂(K_{S}). Each of N and K CRIs or SSBRIs (e.g. CRI #1, CRI #2, . . . , CRI #K) has a value CRI k or SSBRI k (k is from 0 to K_{S}−1). CRI k or SSBRI k indicates the configured (k+1)^{th} entry of the NZP CSI-RS resources or SSB resources in the CMR set.

An L1-RSRP value or a differential L1-RSRP value of the resource indicated by each of K CRIs or SSBRIs is also included in the CSI report. Differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

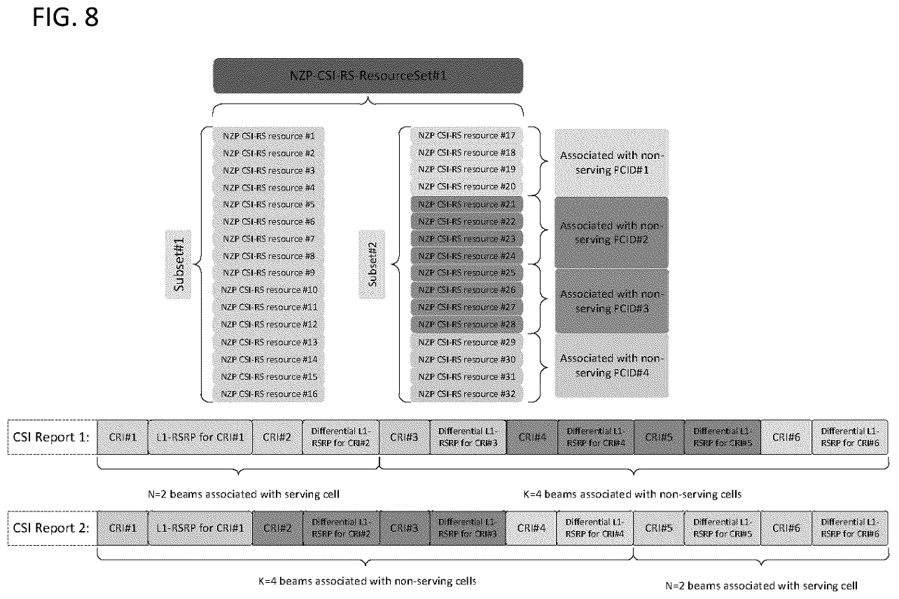

FIG. 8 illustrates an example of the resource setting and the CSI report according to the third sub-embodiment of the second embodiment, where D_{S} (=4) is equal to K (=4).

In the example of FIG. 8, the higher layer parameter reportQuantity is set to ‘cri-RSRP’. Accordingly, the resource setting for channel measurement has one NZP CSI-RS resource set: NZP-CSI-RS-ResourceSet #1 consisting of two subsets: Subset #1 consists of NZP CSI-RS resources #1 to #16 associated with the PCID of the serving cell; and Subset #2 consists of NZP CSI-RS resources #17 to #32, in which NZP CSI-RS resources #17 to #20 are associated with the non-serving PCID #1, NZP CSI-RS resources #21 to #24 are associated with the non-serving PCID #2, NZP CSI-RS resources #25 to #28 are associated with the non-serving PCID #3, NZP CSI-RS resources #29 to #32 are associated with the non-serving PCID #4. As a whole, the NZP CSI-RS resource set consists of 32 NZP CSI-RS resources (i.e. K_{S}=32).

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP value or differential L1-RSRP values of resources indicated by the 6 CRIs, in which 2 of the 6 CRIs (e.g. CRI #1 and CRI #2 in CSI Report 1, or CRI #5 and CRI #6 in CSI Report 2) indicate NZP CSI-RS resources of Subset #1 associated with the PCID of the serving cell, and the other 4 of the 6 CRIs (e.g. CRI #3, CRI #4, CRI #5 and CRI #6 in CSI Report 1, or CRI #1, CRI #2, CRI #3 and CRI #4 in CSI Report 2) indicate NZP CSI-RS resources of Subset #2, in which each of the 4 CRIs indicates an NZP CSI-RS resource associated with a different PCID (one of PCID #1, PCID #2, PCID #3 and PCID #4).

Two examples of CSI report (i.e. CSI Report 1 and CSI Report 2) are illustrated in FIG. 8.

In CSI Report 1, the measured L1-RSRP values of the NZP CSI-RS resources indicated by CRI #1 and CRI #2 are the two largest values among all measured L1-RSRP values of NZP CSI-RS resources #1 to #16 in Subset #1, and each of the measured L1-RSRP values of the NZP CSI-RS resources indicated by CRI #3, CRI #4, CRI #5 and CRI #6, which are associated with a different PCID, i.e. PCID #4, PCID #3, PCID #2 and PCID #1, respectively, is the largest value among all measured L1-RSRP values of NZP CSI-RS resources in Subset #2 associated with the different PCID (e.g. the measured L1-RSRP value of the NZP CSI-RS resource indicated by CRI #3 is the largest value among all measured L1-RSRP values of NZP CSI-RS resources #29 to #32 associated with PCID #4, the measured L1-RSRP value of the NZP CSI-RS resource indicated by CRI #4 is the largest value among all measured L1-RSRP values of NZP CSI-RS resources #25 to #28 associated with PCID #3, the measured L1-RSRP value of the NZP CSI-RS resource indicated by CRI #5 is the largest value among all measured L1-RSRP values of NZP CSI-RS resources #21 to #24 associated with PCID #2, and the measured L1-RSRP value of the NZP CSI-RS resource indicated by CRI #6 is the largest value among all measured L1-RSRP values of NZP CSI-RS resources #17 to #20 associated with PCID #1), in which the measured L1-RSRP value of the NZP CSI-RS resource indicated by CRI #1 is the largest among the measured L1-RSRP values of the NZP CSI-RS resources indicated by CRI #1 to CRI #6.

In CSI Report 2, each of the measured L1-RSRP values of the NZP CSI-RS resources indicated by CRI #1, CRI #2, CRI #3 and CRI #4, which are associated with a different PCID, i.e. PCID #4, PCID #3, PCID #2 and PCID #1, respectively, is the largest value among all measured L1-RSRP values of NZP CSI-RS resources in Subset #2 associated with the different PCID (e.g. the measured L1-RSRP value of the NZP CSI-RS resource indicated by CRI #1 is the largest value among all measured L1-RSRP values of NZP CSI-RS resources #29 to #32 associated with PCID #4, the measured L1-RSRP value of the NZP CSI-RS resource indicated by CRI #2 is the largest value among all measured L1-RSRP values of NZP CSI-RS resources #25 to #28 associated with PCID #3, the measured L1-RSRP value of the NZP CSI-RS resource indicated by CRI #3 is the largest value among all measured L1-RSRP values of NZP CSI-RS resources #21 to #24 associated with PCID #2, and the measured L1-RSRP value of the NZP CSI-RS resource indicated by CRI #4 is the largest value among all measured L1-RSRP values of NZP CSI-RS resources #17 to #20 associated with PCID #1), and the measured L1-RSRP values of the NZP CSI-RS resources indicated by CRI #5 and CRI #6 are the two largest values among all measured L1-RSRP values of NZP CSI-RS resources #1 to #16 in Subset #1, in which the measured L1-RSRP value of the NZP CSI-RS resource indicated by CRI #1 is the largest among the measured L1-RSRP values of the NZP CSI-RS resources indicated by CRI #1 to CRI #6.

The bit width of each of CRI #1, CRI #2, CRI #3, CRI #4, CRI #5 and CRI #6 is ┌log₂(32)┐=5 bits. The possible values of each of CRI #1, CRI #2, CRI #3, CRI #4, CRI #5 and CRI #6 are CRI 0, CRI 1, . . . , and CRI 31. CRI k (k is a value of any of 0 to 31) indicates NZP CSI-RS resource ##(k+1). For example, for CSI Report 1, the possible values of each of CRI #1 and CRI #2 are CRI 0, CRI 1, . . . , and CRI 15; the possible values of CRI #3 are CRI 28, CRI 29, . . . , and CRI 31; the possible values of CRI #4 are CRI 24, CRI 25, . . . , and CRI 27; the possible values of CRI #5 are CRI 20, CRI 21, . . . , and CRI 23; the possible values of CRI #6 are CRI 16, CRI 17, . . . , and CRI 19.

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report has a bit length of 4 bits.

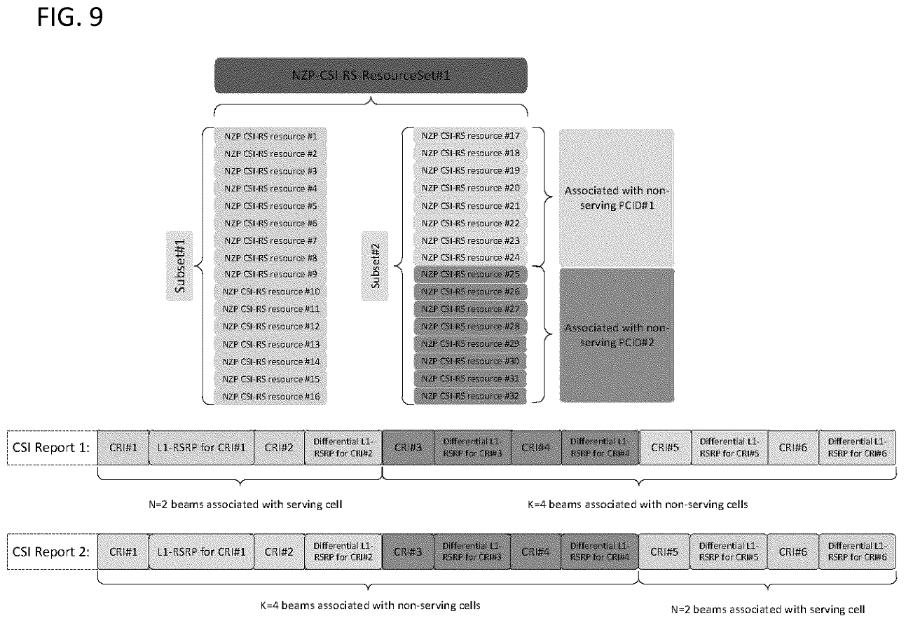

FIG. 9 illustrates another example of the resource setting and the CSI report according to the third sub-embodiment of the second embodiment, where D_{S} (=2) is smaller than K (=4).

In the example of FIG. 9, the higher layer parameter reportQuantity is set to ‘cri-RSRP’. Accordingly, the resource setting for channel measurement has one NZP CSI-RS resource set: NZP-CSI-RS-ResourceSet #1 consisting of two subsets: Subset #1 consists of NZP CSI-RS resources #1 to #16 associated with the PCID of the serving cell; and Subset #2 consists of NZP CSI-RS resources #17 to #32, in which NZP CSI-RS resources #17 to #24 are associated with the non-serving PCID #1, NZP CSI-RS resources #25 to #32 are associated with the non-serving PCID #2. As a whole, the NZP CSI-RS resource set consists of 32 NZP CSI-RS resources (i.e. K_{S}=32).

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP value or differential L1-RSRP values of resources indicated by the 6 CRIs, in which 2 of the 6 CRIs (e.g. CRI #1 and CRI #2 in CSI Report 1, or CRI #5 and CRI #6 in CSI Report 2) indicate NZP CSI-RS resources in Subset #1 associated with the PCID of the serving cell, and the other 4 of the 6 CRIs (e.g. CRI #3, CRI #4, CRI #5 and CRI #6 in CSI Report 1, or CRI #1, CRI #2, CRI #3 and CRI #4 in CSI Report 2) indicate NZP CSI-RS resources in Subset #2, in which every 2 of the 4 CRIs indicates two NZP CSI-RS resources associated with a different PCID (one of PCID #1 and PCID #2).

Two examples of CSI report (i.e. CSI Report 1 and CSI Report 2) are illustrated in FIG. 9.

In CSI Report 1, the measured L1-RSRP values of the NZP CSI-RS resources indicated by CRI #1 and CRI #2 are the two largest values among all measured L1-RSRP values of NZP CSI-RS resources #1 to #16 in Subset #1, and every 2 of the measured L1-RSRP values of the NZP CSI-RS resources indicated by CRI #3, CRI #4, CRI #5 and CRI #6 (e.g. the NZP CSI-RS resources indicated by CRI #5 and CRI #6) are the two largest measured L1-RSRP values of the NZP CSI-RS resources #17 to #24 in Subset #2 associated with PCID #1, and the other 2 of the measured L1-RSRP values of the NZP CSI-RS resources indicated by CRI #3, CRI #4, CRI #5 and CRI #6 (e.g. the NZP CSI-RS resources indicated by CRI #3 and CRI #4) are the two largest measured L1-RSRP values of the NZP CSI-RS resources #25 to #32 in Subset #2 associated with PCID #2, in which the measured L1-RSRP value of the NZP CSI-RS resource indicated by CRI #1 is the largest among the measured L1-RSRP values of the NZP CSI-RS resources indicated by CRI #1 to CRI #6.

In CSI Report 2, every 2 of the measured L1-RSRP values of the NZP CSI-RS resources indicated by CRI #1, CRI #2, CRI #3 and CRI #4 (e.g. the NZP CSI-RS resources indicated by CRI #1 and CRI #2) are the two largest measured L1-RSRP values of the NZP CSI-RS resources #17 to #24 associated with PCID #1, and the other 2 of the measured L1-RSRP values of the NZP CSI-RS resources indicated by CRI #1, CRI #2, CRI #3 and CRI #4 (e.g. the NZP CSI-RS resources indicated by CRI #3 and CRI #4) are the two largest measured L1-RSRP values of the NZP CSI-RS resources #25 to #32 associated with PCID #2, and the measured L1-RSRP values of the NZP CSI-RS resources indicated by CRI #5 and CRI #6 are the two largest values among all measured L1-RSRP values of NZP CSI-RS resources #1 to #16, in which the measured L1-RSRP value of the NZP CSI-RS resource indicated by CRI #1 is the largest among the measured L1-RSRP values of the NZP CSI-RS resources indicated by CRI #1 to CRI #6.

The bit width of each of CRI #1, CRI #2, CRI #3, CRI #4, CRI #5 and CRI #6 is ┌log₂(32)┐=5 bits. The possible values of each of CRI #1, CRI #2, CRI #3, CRI #4, CRI #5 and CRI #6 are CRI 0, CRI 1, . . . , and CRI 31. CRI k (k is a value of any of 0 to 31) indicates NZP CSI-RS resource #(k+1). For example, for CSI Report 1, the possible values of each of CRI #1 and CRI #2 are CRI 0, CRI 1, . . . , and CRI 15; the possible values of each of CRI #3 and CRI #4 are CRI 24, CRI 25, . . . , and CRI 31; and the possible values of each of CRI #5 and CRI #6 are CRI 16, CRI 17, . . . , and CRI 23.

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report has a bit length of 4 bits.

In a fourth sub-embodiment of the second embodiment, two channel measurement resource (CMR) sets are configured in a resource setting for channel measurement for a CSI report. Best K beams from the non-serving cells and best N beams from the serving cell are reported in the CSI report.

The resource setting for channel measurement is associated with a CSI-ReportConfig IE, which configures a CSI Report and has a higher layer parameter reportQuantity (which configures the report contents in the CSI Report), a higher layer parameter nrofReportedRS (which configures the number of reported beams of the serving cell in the CSI Report) and a higher layer parameter nrofReportedRS-Neighboring (which configures the number of reported beams of the non-serving cells in the CSI Report). The number of reported beams of the serving cell is denoted as N, and the number of reported beams of the non-serving cells is denoted as K.

Each of the two CMR sets (also referred to as “each CMR set”) can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’).

One of the two CMR sets (e.g. a first CMR set) consists of resources associated with the PCID of the serving cell, and the other of the two CMR sets (e.g. a second CMR set) consists of resources associated with any of the PCIDs of the non-serving cells. The number of CMR resources (i.e. SSB resources or NZP CSI-RS resources) within the CMR set associated with the PCID of the serving cell is denoted as K_{S}; and the number of CMR resources (i.e. SSB resources or NZP CSI-RS resources) within the CMR set associated with the PCID(s) of the non-serving cell(s) is denoted as K_{NS}.

In the CSI Report according to the fourth sub-embodiment of the second embodiment, K largest measured L1-RSRP values of K NZP CSI-RS resources or SSB resources associated with any of the PCIDs of the non-serving cells and K CRIs or SSBRIs that indicate the K NZP CSI-RS resources or SSB resources, and N largest measured L1-RSRP values of N NZP CSI-RS resources or SSB resources associated with the PCID of the serving cell and N CRIs or SSBRIs that indicate the N NZP CSI-RS resources or SSB resources are reported.

The bit width of each of N CRIs or SSBRIs in the CSI report is determined by ┌log₂(K_{S})┐, which means the smallest integer that is equal to or larger than log₂(K_{S}). Each of N CRIs or SSBRIs (e.g. CRI #1, CRI #2, . . . , CRI #N) has a value CRI n or SSBRI n (n is from 0 to K_{S}−1). CRI n or SSBRI n indicates the configured (n+1)^{th} entry of the NZP CSI-RS resources or SSB resources in the CMR set associated with the PCID of the serving cell.

The bit width of each of K CRIs or SSBRIs in the CSI report is determined by ┌log₂(K_{NS})┐, which means the smallest integer that is equal to or larger than log₂(K_{NS}). Each of K CRIs or SSBRIs (e.g. CRI #1, CRI #2, . . . , CRI #K) has a value CRI k or SSBRI k (k is from 0 to K_{NS}−1). CRI k or SSBRI k indicates the configured (k+1)^{th} entry of the NZP CSI-RS resources or SSB resources in the CMR set associated with any of the PCIDs of the non-serving cells.

An L1-RSRP value or a differential L1-RSRP value of the resource indicated by each of K and N CRIs or SSBRIs is also included in the CSI report. To reduce the L1-RSRP report overhead, differential L1-RSRP reporting is used. In particular, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB.

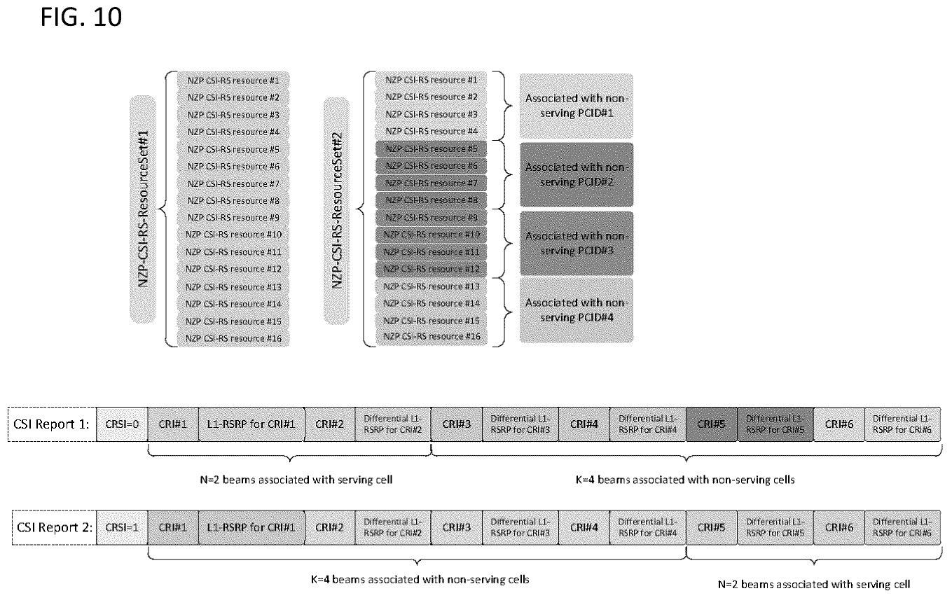

Since the largest measured L1-RSRP value may be from or be associated with any of the two CMR sets. The CMR set ID of the CMR set including the NZP CSI-RS resource or SSB resource having the largest measured L1-RSRP value (indicated by the first CRI or the first SSBRI) is included in the CSI report. In particular, a CSI-RS resource set indicator (CRSI) or a SSB resource set indicator (SSBRSI) is included in the CSI report as the CMR set ID. Therefore, the CMR set ID of the first reported NZP CSI-RS resource or SSB resource (indicated by the first CRI or the first SSBRI) is represented by a CRSI or SSBRSI. The bit width of CRSI or SSBRSI in the CSI report is 1. CRSI or SSBRSI with a value 0 indicates the first CMR set (e.g. NZP-CSI-RS-ResourceSet #1 as shown in FIG. 10), and CRSI or SSBRSI with a value 1 indicates the second CMR set (e.g. NZP-CSI-RS-ResourceSet #2 as shown in FIG. 10).

FIG. 10 illustrates an example of the resource setting and the CSI report according to the fourth sub-embodiment of the second embodiment.

In the example of FIG. 10, the higher layer parameter reportQuantity is set to ‘cri-RSRP’. Accordingly, the resource setting for channel measurement has two NZP CSI-RS resource sets: NZP-CSI-RS-ResourceSet #1 consists of 16 (i.e. K_{S}=16) NZP CSI-RS resources (e.g. NZP CSI-RS resources #1 to #16) associated with the PCID of the serving cell; and NZP-CSI-RS-ResourceSet #2 consists of 16 (i.e. K_{NS}=16) NZP CSI-RS resources (e.g. NZP CSI-RS resources #1 to #16), in which NZP CSI-RS resources #1 to #4 are associated with the non-serving PCID #1, NZP CSI-RS resources #5 to #8 are associated with the non-serving PCID #2, NZP CSI-RS resources #9 to #12 are associated with the non-serving PCID #3, NZP CSI-RS resources #13 to #16 are associated with the non-serving PCID #4.

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP value or differential L1-RSRP values of resources indicated by the 6 CRIs, in which 2 of the 6 CRIs (e.g. CRI #1 and CRI #2 in CSI Report 1, or CRI #5 and CRI #6 in CSI Report 2) indicate NZP CSI-RS resources of NZP-CSI-RS-ResourceSet #1 associated with the PCID of the serving cell, and the other 4 of the 6 CRIs (e.g. CRI #3, CRI #4, CRI #5 and CRI #6 in CSI Report 1, or CRI #1, CRI #2, CRI #3 and CRI #4 in CSI Report 2) indicate NZP CSI-RS resources of NZP-CSI-RS-ResourceSet #2 associated with any of PCID #1, PCID #2, PCID #3 and PCID #4.

Two examples of CSI report (i.e. CSI Report 1 and CSI Report 2) are illustrated in FIG. 10.

In CSI Report 1, CRSI=0, which means that CRI #1 indicates an NZP CSI-RS resource of NZP-CSI-RS-ResourceSet #1. The measured L1-RSRP values of the NZP CSI-RS resources indicated by CRI #1 and CRI #2 are the two largest (i.e. the largest and the second largest) measured values among all measured L1-RSRP values of NZP CSI-RS resources #1 to #16 of NZP-CSI-RS-ResourceSet #1. The measured L1-RSRP values of the NZP CSI-RS resources indicated by CRI #3, CRI #4, CRI #5 and CRI #6 (that are associated with PCID #4, PCID #4, PCID #2 and PCID #1, respectively) are the four largest values among all measured L1-RSRP values of NZP CSI-RS resources #1 to #16 of NZP-CSI-RS-ResourceSet #2. The measured L1-RSRP value of the NZP CSI-RS resource indicated by CRI #1 is the largest among the measured L1-RSRP values of the NZP CSI-RS resources indicated by CRI #1 to CRI #6.

In CSI Report 2, CRSI=1, which means that CRI #1 indicates an NZP CSI-RS resource of NZP-CSI-RS-ResourceSet #2. The measured L1-RSRP values of the NZP CSI-RS resources indicated by CRI #1, CRI #2, CRI #3 and CRI #4 (that are associated with PCID #4, PCID #1, PCID #1 and PCID #1, respectively) are the four largest values among all measured L1-RSRP values of NZP CSI-RS resources #1 to #16 of NZP-CSI-RS-ResourceSet #2, and the measured L1-RSRP values of the NZP CSI-RS resources indicated by CRI #5 and CRI #6 are the two largest values among all measured L1-RSRP values of NZP CSI-RS resources #1 to #16 of NZP-CSI-RS-ResourceSet #1. The measured L1-RSRP value of the NZP CSI-RS resource indicated by CRI #1 is the largest among the measured L1-RSRP values of the NZP CSI-RS resources indicated by CRI #1 to CRI #6.

The bit width of each of CRIs that indicates an NZP CSI-RS resource of NZP-CSI-RS-ResourceSet #1 (e.g. CRI #1 and CRI #2 in CSI Report 1, CRI #5 and CRI #6 in CSI Report 2) is ┌log₂(K_{S})┐=┌log₂(16)┐=4 bits. The possible values of each of CRIs that indicates an NZP CSI-RS resource of NZP-CSI-RS-ResourceSet #1 are CRI 0, CRI 1, . . . , and CRI 15. CRI n (n is a value of any of 0 to 15) indicates NZP CSI-RS resource #(k+1) of NZP-CSI-RS-ResourceSct #1.

The bit width of each of CRIs that indicates an NZP CSI-RS resource of NZP-CSI-RS-ResourceSet #2 (e.g. CRI #3, CRI #4, CRI #5 and CRI #6 in CSI Report 1, CRI #1, CRI #2, CRI #and CRI #4 in CSI Report 2) is ┌log₂(K_{NS})┐=┌log₂(16)┐=4 bits. The possible values of each of CRIs that indicates an NZP CSI-RS resource of NZP-CSI-RS-ResourceSet #2 are CRI 0, CRI 1, . . . , and CRI 15. CRI k (k is a value of any of 0 to 15) indicates NZP CSI-RS resource #(k+1) of NZP-CSI-RS-ResourceSet #2.

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report has a bit length of 4 bits.

In a fifth sub-embodiment of the second embodiment, two channel measurement resource (CMR) sets are configured in a resource setting for channel measurement for a CSI report. Best K beams from the non-serving cells and best N beams from the serving cell are reported in the CSI report, where each of the K beams (or every P beams of the K beams) is from a different non-serving cell.

The resource setting for channel measurement is associated with a CSI-ReportConfig IE, which configures a CSI Report and has a higher layer parameter reportQuantity (which configures the report contents in the CSI Report), a higher layer parameter nrofReportedRS (which configures the number of reported beams of the serving cell in the CSI Report) and a higher layer parameter nrofReportedRS-Neighboring (which configures the number of reported beams of the non-serving cells in the CSI Report). The number of reported beams of the serving cell is denoted as N, and the number of reported beams of the non-serving cells is denoted as K.

All the resources within the CMR set may be from or be associated with the serving cell and one or multiple non-serving cells. In some scenario, the gNB may want to know the qualities of both the serving cell and some neighboring cells (non-serving cells).

Each of the two CMR sets (also referred to as “each CMR set”) can be a CSI-SSB resource set consisting of SSB resources from non-serving cells (if the higher layer parameter reportQuantity is set to ‘ssb-Index-RSRP’) or an NZP CSI-RS resource set consisting of NZP CSI-RS resources QCLed and associated with SSB resources from non-serving cells (if the higher layer parameter reportQuantity is set to ‘cri-RSRP’).

One of the two CMR sets (e.g. a first CMR set) consists of resources associated with the PCID of the serving cell, and the other of the two CMR sets (e.g. a second CMR set) consists of resources associated with any of the PCIDs of the non-serving cells. The number of CMR resources (i.e. SSB resources or NZP CSI-RS resources) within the CMR set associated with the PCID of the serving cell is denoted as K_{S}; and the number of CMR resources (i.e. SSB resources or NZP CSI-RS resources) within the CMR set associated with the PCID(s) of the non-serving cell(s) is denoted as K_{NS}. The number of PCIDs of the non-serving cells is denoted as D_{S} (D_{S} is 1 or more).

In the CSI Report according to the fifth sub-embodiment of the second embodiment, K largest measured L1-RSRP values of K NZP CSI-RS resources or SSB resources associated with the PCIDs of the non-serving cells and K CRIs or SSBRIs that indicate the K NZP CSI-RS resources or SSB resources, and N largest measured L1-RSRP values of N NZP CSI-RS resources or SSB resources associated with the PCID of the serving cell and N CRIs or SSBRIs that indicate the N NZP CSI-RS resources or SSB resources are reported.

If D_{S} is equal to or larger than K, each of the K NZP CSI-RS resources or SSB resources associated with the PCIDs of the non-serving cells is associated with a different PCID.

If D_{S} is smaller than K, then K is configured as a multiple of D_{S}, e.g. K=P*D_{S}. Every P of K CRIs or SSBRIs indicate P NZP CSI-RS resources or SSB resources of the K NZP CSI-RS resources or SSB resources associated with the PCIDs of the non-serving cells associated with a different PCID.

The bit width of each of N CRIs or SSBRIs in the CSI report is determined by ┌log₂(K_{S})┐, which means the smallest integer that is equal to or larger than log₂(K_{S}). Each of N CRIs or SSBRIs (e.g. CRI #1, CRI #2, . . . , CRI #N) has a value CRI n or SSBRI n (n is from 0 to K_{S}−1). CRI n or SSBRI n indicates the configured (n+1)^{th} entry of the NZP CSI-RS resources or SSB resources in the CMR set associated with the PCID of the serving cell.

The bit width of each of K CRIs or SSBRIs in the CSI report is determined by ┌log₂(K_{NS})┐, which means the smallest integer that is equal to or larger than log₂(K_{NS}). Each of K CRIs or SSBRIs (e.g. CRI #1, CRI #2, . . . , CRI #K) has a value CRI k or SSBRI k (k is from 0 to K_{NS}−1). CRI k or SSBRI k indicates the configured (k+1)^{th} entry of the NZP CSI-RS resources or SSB resources in the CMR set associated with any of the PCIDs of the non-serving cells.

An L1-RSRP value or a differential L1-RSRP value of the resource indicated by each of N and K CRIs or SSBRIs is also included in the CSI report. Differential L1-RSRP reporting is used.

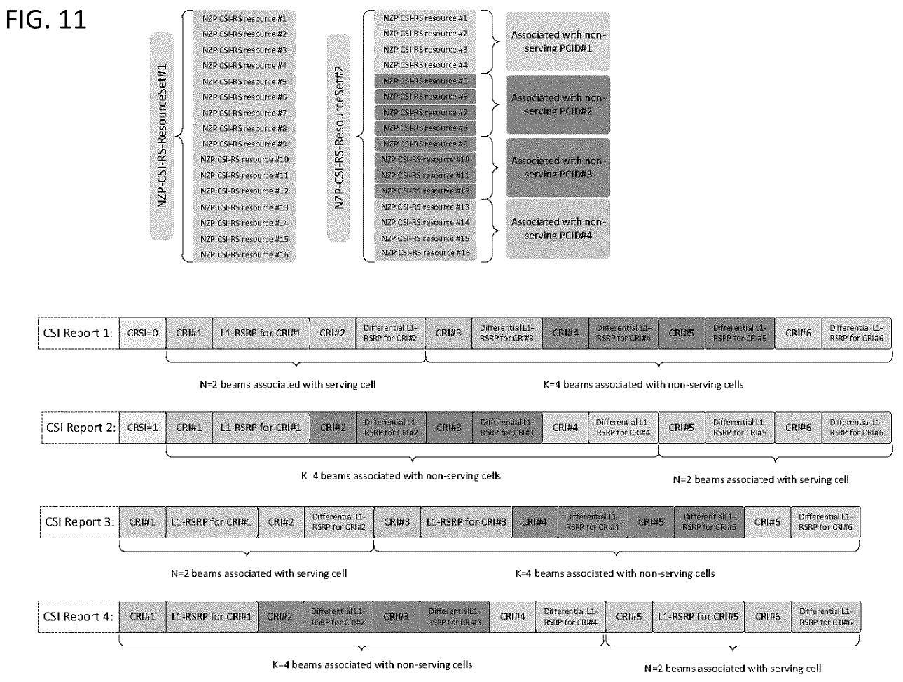

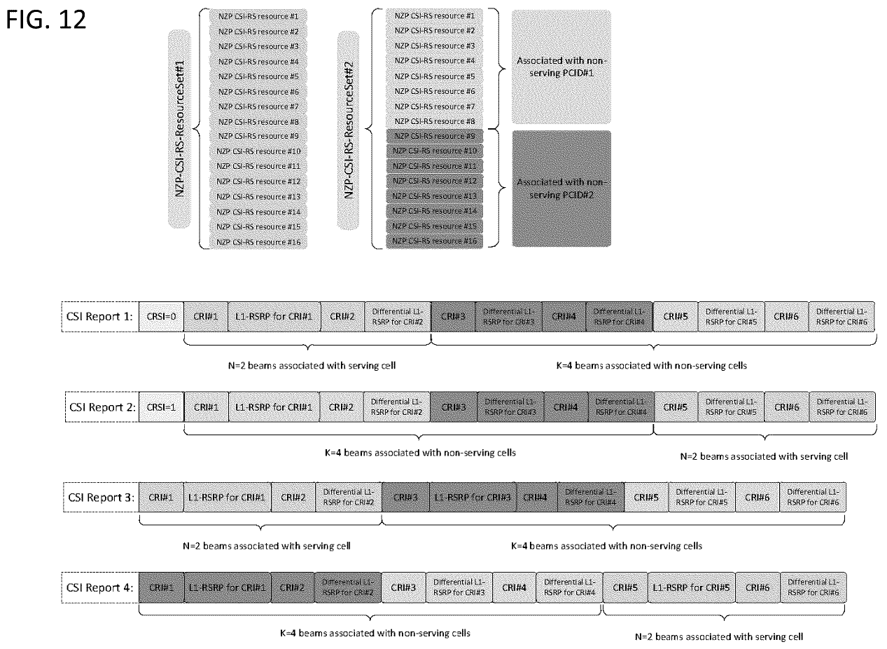

In a first configuration of the CSI report, the first reported NZP CSI-RS resource (indicated by the first CRI) or the first reported SSB resource (indicated by the first SSBRI) has the largest measured L1-RSRP value, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource is represented by a differential L1-RSRP value relative to the largest measured L1-RSRP value, where each differential L1-RSRP value is quantized to a 4-bit value with a step size of 2 dB. Since the largest measured L1-RSRP value may be from or be associated with any of the two CMR sets. The CMR set ID of the CMR set including the NZP CSI-RS resource or SSB resource having the largest measured L1-RSRP value (indicated by the first CRI or the first SSBRI) is included in the CSI report. In particular, a CSI-RS resource set indicator (CRSI) or a SSB resource set indicator (SSBRSI) is included in the CSI report as the CMR set ID. Therefore, the CMR set ID of the first reported NZP CSI-RS resource or SSB resource (indicated by the first CRI or the first SSBRI) is represented by a CRSI or SSBRSI. The bit width of CRSI or SSBRSI in the first configuration of the CSI report is 1. CRSI or SSBRSI with a value 0 indicates the first CMR set (e.g. NZP-CSI-RS-ResourceSet #1 as shown in FIG. 11 or FIG. 12), and CRSI or SSBRSI with a value 1 indicates the second CMR set (e.g. NZP-CSI-RS-ResourceSet #2 as shown in FIG. 11 or FIG. 12).

In a second configuration of the CSI report, the first reported NZP CSI-RS resource (indicated by the first CRI) or the first reported SSB resource (indicated by the first SSBRI) has the largest measured L1-RSRP value among the NZP CSI-RS resources or SSB resources of a first CMR set associated with the PCID of the serving cell, which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource from the first CMR set is represented by a differential L1-RSRP value relative to the largest measured L1-RSRP value, where each differential L1-RSRP value is quantized to a 4-bit value with a step size of 2 dB. In addition, the (N+1)^{th} reported NZP CSI-RS resource or SSB resource has the largest measured L1-RSRP value among the NZP CSI-RS resources or SSB resources of a second CMR set associated with the PCID(s) of the non-serving cells, which is quantized to a 7-bit value in the range [−140, −44] dBm with a step size of 1 dB. Each of the measured L1-RSRP values of the other reported NZP CSI-RS resources or SSB resources than the (N+1)^{th} reported NZP CSI-RS resource or SSB resource from the second CMR set is represented by a differential L1-RSRP value relative to the largest measured L1-RSRP value, where each differential L1-RSRP value is quantized to a 4-bit value with a step size of 2 dB.

In a third configuration of the CSI report, the first reported NZP CSI-RS resource (indicated by the first CRI) or the first reported SSB resource (indicated by the first SSBRI) has the largest measured L1-RSRP value among the NZP CSI-RS resources or SSB resources of a second CMR set associated with the PCID(s) of the non-serving cell(s), which is quantized to a 7-bit value in the range [−140, −44] dBm with a step size of 1 dB. Each of the measured L1-RSRP values of the other reported NZP CSI-RS resources or SSB resources than the first reported NZP CSI-RS resource or SSB resource from the second CMR set is represented by a differential L1-RSRP value relative to the largest measured L1-RSRP value, where each differential L1-RSRP value is quantized to a 4-bit value with a step size of 2 dB. In addition, the (K+1)^{th} reported NZP CSI-RS resource or SSB resource has the largest measured L1-RSRP value among the NZP CSI-RS resources or SSB resources of a first CMR set associated with the PCID of the serving cell, which is quantized to a 7-bit value in the range [−140, −44] dBm with a step size of 1 dB. Each of the measured L1-RSRP values of the other reported NZP CSI-RS resources or SSB resources than the (K+1)^{th} reported NZP CSI-RS resource or SSB resource from the first CMR set is represented by a differential L1-RSRP value relative to the largest measured L1-RSRP value, where each differential L1-RSRP value is quantized to a 4-bit value with a step size of 2 dB.

FIG. 11 illustrates an example of the resource setting and the CSI report according to the fifth sub-embodiment of the second embodiment, where D_{S} (=4) is equal to K (=4).

In the example of FIG. 11, the higher layer parameter reportQuantity is set to ‘cri-RSRP’. Accordingly, the resource setting for channel measurement has two NZP CSI-RS resource sets: NZP-CSI-RS-ResourceSet #1 consists of 16 (i.e. K_{S}=16) NZP CSI-RS resources (e.g. NZP CSI-RS resources #1 to #16) associated with the PCID of the serving cell; and NZP-CSI-RS-ResourceSet #2 consists of 16 (i.e. K_{NS}=16) NZP CSI-RS resources (e.g. NZP CSI-RS resources #1 to #16), in which NZP CSI-RS resources #1 to #4 are associated with the non-serving PCID #1, NZP CSI-RS resources #5 to #8 are associated with the non-serving PCID #2, NZP CSI-RS resources #9 to #12 are associated with the non-serving PCID #3, NZP CSI-RS resources #13 to #16 are associated with the non-serving PCID #4.

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP values or differential L1-RSRP values of resources indicated by the 6 CRIs, in which 2 of the 6 CRIs (e.g. CRI #1 and CRI #2 in CSI Report 1 or CSI Report 3, or CRI #5 and CRI #6 in CSI Report 2 or CSI Report 4) indicate NZP CSI-RS resources of Subset #1 associated with the PCID of the serving cell, and the other 4 of the 6 CRIs (e.g. CRI #3, CRI #4, CRI #5 and CRI #6 in CSI Report 1 or CSI Report 3, or CRI #1, CRI #2, CRI #3 and CRI #4 in CSI Report 2 or CSI Report 4) indicate NZP CSI-RS resources of Subset #2, in which each of the 4 CRIs indicates an NZP CSI-RS resource associated with a different PCID (one of PCID #1, PCID #2, PCID #3 and PCID #4).

Four examples of CSI report (i.e. CSI Report 1, CSI Report 2, CSI Report 3 and CSI Report 4) are illustrated in FIG. 11.

In CSI Report 1 (an example of the first configuration), CRSI=0, which means that CRI #1 indicates an NZP CSI-RS resource of NZP-CSI-RS-ResourceSet #1. The measured L1-RSRP values of the NZP CSI-RS resources indicated by CRI #1 and CRI #2 are the two largest (i.e. the largest and the second largest) values among all measured L1-RSRP values of NZP CSI-RS resources #1 to #16 of NZP-CSI-RS-ResourceSet #1. Each of the measured L1-RSRP values of the NZP CSI-RS resources indicated by CRI #3, CRI #4, CRI #5 and CRI #6, which are associated with a different PCID, i.e. PCID #4, PCID #3, PCID #2 and PCID #1, respectively, is the largest value among all measured L1-RSRP values of NZP CSI-RS resources associated with the different PCID (e.g. the measured L1-RSRP value of the NZP CSI-RS resource indicated by CRI #3 is the largest value among all measured L1-RSRP values of NZP CSI-RS resources #13 to #16 of NZP-CSI-RS-ResourceSet #2 associated with PCID #4, the measured L1-RSRP value of the NZP CSI-RS resource indicated by CRI #4 is the largest value among all measured L1-RSRP values of NZP CSI-RS resources #9 to #12 of NZP-CSI-RS-ResourceSet #2 associated with PCID #3, the measured L1-RSRP value of the NZP CSI-RS resource indicated by CRI #5 is the largest value among all measured L1-RSRP values of NZP CSI-RS resources #5 to #8 of NZP-CSI-RS-ResourceSet #2 associated with PCID #2, and the measured L1-RSRP value of the NZP CSI-RS resource indicated by CRI #6 is the largest value among all measured L1-RSRP values of NZP CSI-RS resources #1 to #4 of NZP-CSI-RS-ResourceSet #2 associated with PCID #1), in which the measured L1-RSRP value of the NZP CSI-RS resource indicated by CRI #1 is the largest among the measured L1-RSRP values of the NZP CSI-RS resources indicated by CRI #1 to CRI #6.

In CSI Report 2 (another example of the first configuration), CRSI=1, which means that CRI #1 indicates an NZP CSI-RS resource of NZP-CSI-RS-ResourceSet #2. Each of the measured L1-RSRP values of the NZP CSI-RS resources indicated by CRI #1, CRI #2, CRI #3 and CRI #4, which are associated with a different PCID, i.e. PCID #4, PCID #3, PCID #2 and PCID #1, respectively, is the largest value among all measured L1-RSRP values of NZP CSI-RS resources associated with the different PCID (e.g. the measured L1-RSRP value of the NZP CSI-RS resource indicated by CRI #1 is the largest value among all measured L1-RSRP values of NZP CSI-RS resources #13 to #16 of NZP-CSI-RS-ResourceSet #2 associated with PCID #4, the measured L1-RSRP value of the NZP CSI-RS resource indicated by CRI #2 is the largest value among all measured L1-RSRP values of NZP CSI-RS resources #9 to #12 of NZP-CSI-RS-ResourceSet #2 associated with PCID #3, the measured L1-RSRP value of the NZP CSI-RS resource indicated by CRI #3 is the largest value among all measured L1-RSRP values of NZP CSI-RS resources #5 to #8 of NZP-CSI-RS-ResourceSet #2 associated with PCID #2, and the measured L1-RSRP value of the NZP CSI-RS resource indicated by CRI #4 is the largest value among all measured L1-RSRP values of NZP CSI-RS resources #1 to #4 of NZP-CSI-RS-ResourceSet #2 associated with PCID #1). The measured L1-RSRP values of the NZP CSI-RS resources indicated by CRI #5 and CRI #6 are the two largest values among all measured L1-RSRP values of NZP CSI-RS resources #1 to #16 of NZP-CSI-RS-ResourceSet #1. The measured L1-RSRP value of the NZP CSI-RS resource indicated by CRI #1 is the largest among the measured L1-RSRP values of the NZP CSI-RS resources indicated by CRI #1 to CRI #6.

The bit width of each of CRIs that indicates an NZP CSI-RS resource of NZP-CSI-RS-ResourceSet #1 (e.g. CRI #1 and CRI #2 in CSI Report 1, CRI #5 and CRI #6 in CSI Report 2) is ┌log₂(K_{S})┐=┌log₂(16)┐=4 bits. The possible values of each of CRIs that indicates an NZP CSI-RS resource of NZP-CSI-RS-ResourceSet #1 are CRI 0, CRI 1, . . . , and CRI 15. CRI n (n is a value of any of 0 to 15) indicates NZP CSI-RS resource #(k+1) of NZP-CSI-RS-ResourceSet #1.

The bit width of each of CRIs that indicates an NZP CSI-RS resource of NZP-CSI-RS-ResourceSet #2 (e.g. CRI #3, CRI #4, CRI #5 and CRI #6 in CSI Report 1, CRI #1, CRI #2, CRI #and CRI #4 in CSI Report 2) is ┌log₂(K_{NS})┐=┌log₂(16)┐=4 bits. The possible values each of CRIs that indicates an NZP CSI-RS resource of NZP-CSI-RS-ResourceSet #2 are CRI 0, CRI 1, . . . , and CRI 15. CRI k (k is a value of any of 0 to 15) indicates NZP CSI-RS resource #(k+1) of NZP-CSI-RS-ResourceSet #2.

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report 1 or 2 has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report 1 or 2 has a bit length of 4 bits.

CSI Report 3 (an example of the second configuration) differs from CSI Report 1 in that
(1) no CRSI field is contained, and
(2) the L1-RSRP value for CRI #3 is quantized to a 7-bit value in the range [−140, −44] dBm with a step size of 1 dB, while the measured L1-RSRP value of each of the NZP CSI-RS resources indicated by CRI #4, CRI #5 and CRI #6 is represented by a differential L1-RSRP value relative to the value of CRI #3. Each of the differential L1-RSRP values for CRI #4, CRI #5 and CRI #6 is quantized to a 4-bit value with a step size of 2 dB.

CSI Report 4 (an example of the third configuration) differs from CSI Report 2 in that
(1) no CRSI field is contained, and
(2) the L1-RSRP value for CRI #5 is quantized to a 7-bit value in the range [−140, −44] dBm with a step size of 1 dB, while the measured L1-RSRP value of the NZP CSI-RS resource indicated by CRI #6 is represented by a differential L1-RSRP value relative to the value of CRI #5. The differential L1-RSRP value for CRI #6 is quantized to a 4-bit value with a step size of 2 dB.

FIG. 12 illustrates another example of the resource setting and the CSI report according to the fifth sub-embodiment of the second embodiment, where D_{S} (=2) is smaller than K (=4).

In the example of FIG. 12, the higher layer parameter reportQuantity is set to ‘cri-RSRP’. Accordingly, the resource setting for channel measurement has two NZP CSI-RS resource sets: NZP-CSI-RS-ResourceSet #1 consists of 16 (i.e. K_{S}=16) NZP CSI-RS resources (e.g. NZP CSI-RS resources #1 to #16) associated with the PCID of the serving cell; and NZP-CSI-RS-ResourceSet #2 consists of 16 (i.e. K_{NS}=16) NZP CSI-RS resources (e.g. NZP CSI-RS resources #1 to #16), in which NZP CSI-RS resources #1 to #8 are associated with the non-serving PCID #1, NZP CSI-RS resources #9 to #16 are associated with the non-serving PCID #2.

The higher layer parameter nrofReportedRS is set to 2 (i.e. N=2), and the higher layer parameter nrofReportedRS-Neighboring is set to 4 (i.e. K=4). Accordingly, the CSI report includes 6 (=2+4) CRIs (e.g. CRI #1, CRI #2, CRI #3, CRI #4, CRI #5 and CRI #6) and the L1-RSRP value or differential L1-RSRP values of resources indicated by the 6 CRIs, in which 2 of the 6 CRIs (e.g. CRI #1 and CRI #2 in CSI Report 1 or CSI Report 3, or CRI #5 and CRI #6 in CSI Report 2 or CSI Report 4) indicate NZP CSI-RS resources of Subset #1 associated with the PCID of the serving cell, and the other 4 of the 6 CRIs (e.g. CRI #3, CRI #4, CRI #5 and CRI #6 in CSI Report 1 or CSI Report 3, or CRI #1, CRI #2, CRI #3 and CRI #4 in CSI Report 2 or CSI Report 4) indicate NZP CSI-RS resources of Subset #2, in which every 2 of the 4 CRIs indicates two NZP CSI-RS resources associated with a different PCID (one of PCID #1 and PCID #2).

Four examples of CSI report (i.e. CSI Report 1, CSI Report 2, CSI Report 3 and CSI Report 4) are illustrated in FIG. 12.

In CSI Report 1 (an example of the first configuration), CRSI=0, which means that CRI #1 indicates an NZP CSI-RS resource of NZP-CSI-RS-ResourceSet #1. The measured L1-RSRP values of the NZP CSI-RS resources indicated by CRI #1 and CRI #2 are the two largest (i.e. the largest and the second largest) values among all measured L1-RSRP values of NZP CSI-RS resources #1 to #16 of NZP-CSI-RS-ResourceSet #1. Every 2 of the measured L1-RSRP values of the NZP CSI-RS resources indicated by CRI #3, CRI #4, CRI #5 and CRI #6 (e.g. the NZP CSI-RS resources indicated by CRI #5 and CRI #6) are the two largest measured L1-RSRP values of the NZP CSI-RS resources #1 to #8 of NZP-CSI-RS-ResourceSet #2 associated with PCID #1, and the other 2 of the measured L1-RSRP values of the NZP CSI-RS resources indicated by CRI #3, CRI #4, CRI #5 and CRI #6 (e.g. the NZP CSI-RS resources indicated by CRI #3 and CRI #4) are the two largest measured L1-RSRP values of the NZP CSI-RS resources #9 to #16 of NZP-CSI-RS-ResourceSet #2 associated with PCID #2, in which the measured L1-RSRP value of the NZP CSI-RS resource indicated by CRI #1 is the largest among the measured L1-RSRP values of the NZP CSI-RS resources indicated by CRI #1 to CRI #6.

In CSI Report 2, (another example of the first configuration), CRSI=1, which means that CRI #1 indicates an NZP CSI-RS resource of NZP-CSI-RS-ResourceSet #2. Every 2 of the measured L1-RSRP values of the NZP CSI-RS resources indicated by CRI #1, CRI #2, CRI #3 and CRI #4 (e.g. the NZP CSI-RS resources indicated by CRI #1 and CRI #2) are the two largest measured L1-RSRP values of the NZP CSI-RS resources #1 to #7 of NZP-CSI-RS-ResourceSet #2 associated with PCID #1, and the other 2 of the measured L1-RSRP values of the NZP CSI-RS resources indicated by CRI #1, CRI #2, CRI #3 and CRI #4 (e.g. the NZP CSI-RS resources indicated by CRI #3 and CRI #4) are the two largest measured L1-RSRP values of the NZP CSI-RS resources #9 to #16 of NZP-CSI-RS-ResourceSet #2 associated with PCID #2. The measured L1-RSRP values of the NZP CSI-RS resources indicated by CRI #5 and CRI #6 are the two largest values among all measured L1-RSRP values of NZP CSI-RS resources #1 to #16 of NZP-CSI-RS-ResourceSet #1. The measured L1-RSRP value of the NZP CSI-RS resource indicated by CRI #1 is the largest among the measured L1-RSRP values of the NZP CSI-RS resources indicated by CRI #1 to CRI #6.

The bit width of each of CRIs that indicates an NZP CSI-RS resource of NZP-CSI-RS-ResourceSet #1 (e.g. CRI #1 and CRI #2 in CSI Report 1, CRI #5 and CRI #6 in CSI Report 2) is ┌log₂(K_{S})┐=┌log₂(16)┐=4 bits. The possible values of each of CRIs that indicates an NZP CSI-RS resource of NZP-CSI-RS-ResourceSet #1 are CRI 0, CRI 1, . . . , and CRI 15. CRI n (n is a value of any of 0 to 15) indicates NZP CSI-RS resource #(k+1) of NZP-CSI-RS-ResourceSet #1.

The bit width of each of CRIs that indicates an NZP CSI-RS resource of NZP-CSI-RS-ResourceSet #2 (e.g. CRI #3, CRI #4, CRI #5 and CRI #6 in CSI Report 1, or CRI #1, CRI #2, CRI #and CRI #4 in CSI Report 2) is ┌log₂(K_{NS})┐=┌log₂(16)┐=4 bits. The possible values of each of CRIs that indicates an NZP CSI-RS resource of NZP-CSI-RS-ResourceSet #2 are CRI 0, CRI 1, . . . , and CRI 15. CRI k (k is a value of any of 0 to 15) indicates NZP CSI-RS resource #(k+1) of NZP-CSI-RS-ResourceSet #2.

The NZP CSI-RS resource indicated by CRI #1 has the largest measured L1-RSRP value, which is quantized to a 7-bit value in the range [−140, −44] dBm with a step size of 1 dB. Therefore, the L1-RSRP value for CRI #1 in the CSI Report has a bit length of 7 bits. The measured L1-RSRP value of each of the NZP CSI-RS resources indicated by CRI #2, CRI #3, CRI #4, CRI #5 and CRI #6 is represented by a differential L1-RSRP value relative to the largest measured L1-RSRP value (i.e. the value of CRI #1). Each of the differential L1-RSRP values is quantized to a 4-bit value with a step size of 2 dB. Therefore, each of the differential L1-RSRP values for CRI #2, CRI #3, CRI #4, CRI #5 and CRI #6 in the CSI Report has a bit length of 4 bits.

CSI Report 3 (an example of the second configuration) differs from CSI Report 1 in that
(1) no CRSI field is contained, and
(2) the L1-RSRP value for CRI #3 is quantized to a 7-bit value in the range [−140, −44] dBm with a step size of 1 dB, while the measured L1-RSRP value of each of the NZP CSI-RS resources indicated by CRI #4, CRI #5 and CRI #6 is represented by a differential L1-RSRP value relative to the value of CRI #3. Each of the differential L1-RSRP values for CRI #4, CRI #5 and CRI #6 is quantized to a 4-bit value with a step size of 2 dB.

CSI Report 4 (an example of the third configuration) differs from CSI Report 2 in that
(1) no CRSI field is contained, and
(2) the L1-RSRP value for CRI #5 is quantized to a 7-bit value in the range [−140, −44] dBm with a step size of 1 dB, while the measured L1-RSRP value of the NZP CSI-RS resource indicated by CRI #6 is represented by a differential L1-RSRP value relative to the value of CRI #5. The differential L1-RSRP value for CRI #6 is quantized to a 4-bit value with a step size of 2 dB.

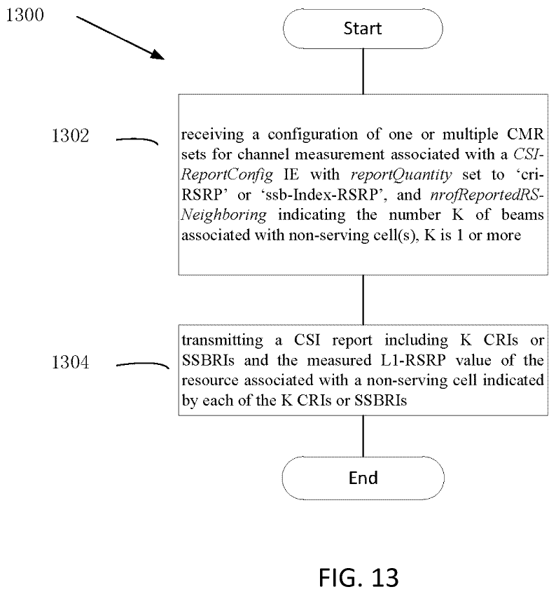

FIG. 13 is a schematic flow chart diagram illustrating an embodiment of a method 1300 according to the present application. In some embodiments, the method 1300 is performed by an apparatus, such as a remote unit (UE). In certain embodiments, the method 1300 may be performed by a processor executing program code, for example, a microcontroller, a microprocessor, a CPU, a GPU, an auxiliary processing unit, a FPGA, or the like.

The method 1300 may include 1302 receiving a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and 1304 transmitting a CSI report including K CRIs or SSBRIs and the measured L1-RSRP value of the resource associated with a non-serving cell indicated by each of the K CRIs or SSBRIs.

In one embodiment, one CMR set including resources associated with one or more non-serving cell(s) is configured. The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In another embodiment, a multiple of CMR sets, each of which includes resources associated with a different non-serving cell, are configured. The resource indicated by each of the K CRIs or SSBRIs is associated with any of the CMR sets. Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In some embodiment, the CSI-ReportConfig IE further has nrofReportedRS indicating the number N of beams associated with a serving cell, N is 1 or more, and the CSI report further includes N CRIs or SSBRIs and the measured L1-RSRP value of the resource associated with the serving cell indicated by each of the N CRIs or SSBRIs.

In one embodiment, one CMR set including two subsets is configured, a first subset of the two subsets includes resources associated with the serving cell and a second subset of the two subsets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In another embodiment, two CMR sets are configured, a first CMR set of the two CMR sets includes resources associated with the serving cell, and a second CMR set of the two CMR sets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell. In some embodiment, the largest measured L1-RSRP value of the resources associated with the first CMR set is quantized to a 7-bit value in the range [−140, −44] dBm with step size of 1 dB, each of the other measured L1-RSRP values of the resource(s) associated with the first CMR set is represented by a differential L1-RSRP value, which is quantized to a 4-bit value with step size of 2 dB, relative to the largest measured L1-RSRP value of the resources associated with the first CMR set, while the largest measured L1-RSRP value of the resources associated with the second CMR set is quantized to a 7-bit value in the range [−140, −44] dBm with step size of 1 dB, each of the other measured L1-RSRP values of the resource(s) associated with the second CMR set is represented by a differential L1-RSRP value, which is quantized to a 4-bit value with step size of 2 dB relative to the largest measured L1-RSRP value of the resources associated with the second CMR set.

In some embodiment, the resources associated with a different non-serving cell are associated with a different PCID, and the resources associated with a same non-serving cell are associated with a same PCID.

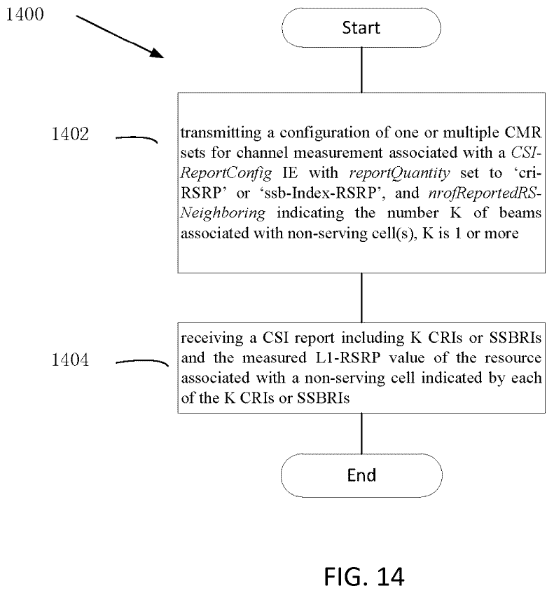

FIG. 14 is a schematic flow chart diagram illustrating a further embodiment of a method 1400 according to the present application. In some embodiments, the method 1400 is performed by an apparatus, such as a base unit. In certain embodiments, the method 1400 may be performed by a processor executing program code, for example, a microcontroller, a microprocessor, a CPU, a GPU, an auxiliary processing unit, a FPGA, or the like.

The method 1400 may include 1402 transmitting a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and 1404 receiving a CSI report including K CRIs or SSBRIs and the measured L1-RSRP value of the resource associated with a non-serving cell indicated by each of the K CRIs or SSBRIs.

In one embodiment, one CMR set including resources associated with one or more non-serving cell(s) is configured. The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In another embodiment, a multiple of CMR sets, each of which includes resources associated with a different non-serving cell, are configured. The resource indicated by each of the K CRIs or SSBRIs is associated with any of the CMR sets. Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In some embodiment, the CSI-ReportConfig IE further has nrofReportedRS indicating the number N of beams associated with a serving cell, N is 1 or more, and the CSI report further includes N CRIs or SSBRIs and the measured L1-RSRP value of the resource associated with the serving cell indicated by each of the N CRIs or SSBRIs.

In one embodiment, one CMR set including two subsets is configured, a first subset of the two subsets includes resources associated with the serving cell and a second subset of the two subsets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In another embodiment, two CMR sets are configured, a first CMR set of the two CMR sets includes resources associated with the serving cell, and a second CMR set of the two CMR sets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell. In some embodiment, the largest measured L1-RSRP value of the resources associated with the first CMR set is quantized to a 7-bit value in the range [−140, −44] dBm with step size of 1 dB, each of the other measured L1-RSRP values of the resource(s) associated with the first CMR set is represented by a differential L1-RSRP value, which is quantized to a 4-bit value with step size of 2 dB, relative to the largest measured L1-RSRP value of the resources associated with the first CMR set, while the largest measured L1-RSRP value of the resources associated with the second CMR set is quantized to a 7-bit value in the range [−140, −44] dBm with step size of 1 dB, each of the other measured L1-RSRP values of the resource(s) associated with the second CMR set is represented by a differential L1-RSRP value, which is quantized to a 4-bit value with step size of 2 dB relative to the largest measured L1-RSRP value of the resources associated with the second CMR set.

In some embodiment, the resources associated with a different non-serving cell are associated with a different PCID, and the resources associated with a same non-serving cell are associated with a same PCID.

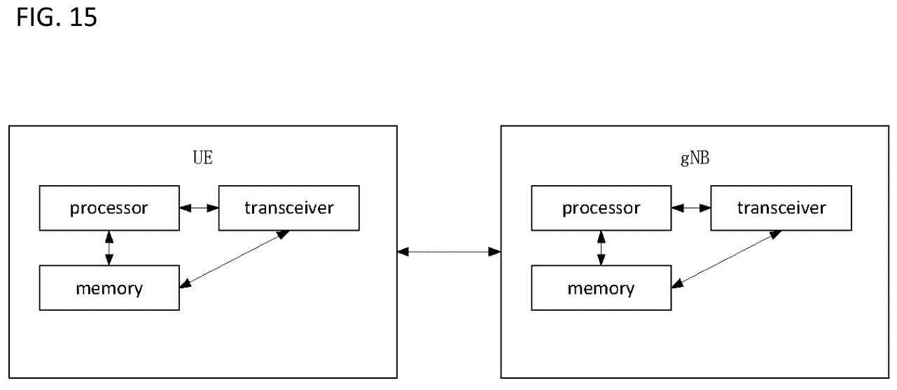

FIG. 15 is a schematic block diagram illustrating apparatuses according to one embodiment.

Referring to FIG. 15, the UE (i.e. the remote unit) includes a processor, a memory, and a transceiver. The processor implements a function, a process, and/or a method which are proposed in FIG. 13.

The UE comprises a receiver that receives a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and a transmitter that transmits a CSI report including K CRIs or SSBRIs and the measured L1-RSRP value of the resource associated with a non-serving cell indicated by each of the K CRIs or SSBRIs.

In one embodiment, one CMR set including resources associated with one or more non-serving cell(s) is configured. The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In another embodiment, a multiple of CMR sets, each of which includes resources associated with a different non-serving cell, are configured. The resource indicated by each of the K CRIs or SSBRIs is associated with any of the CMR sets. Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In some embodiment, the CSI-ReportConfig IE further has nrofReportedRS indicating the number N of beams associated with a serving cell, N is 1 or more, and the CSI report further includes N CRIs or SSBRIs and the measured L1-RSRP value of the resource associated with the serving cell indicated by each of the N CRIs or SSBRIs.

In one embodiment, one CMR set including two subsets is configured, a first subset of the two subsets includes resources associated with the serving cell and a second subset of the two subsets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In another embodiment, two CMR sets are configured, a first CMR set of the two CMR sets includes resources associated with the serving cell, and a second CMR set of the two CMR sets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell. In some embodiment, the largest measured L1-RSRP value of the resources associated with the first CMR set is quantized to a 7-bit value in the range [−140, −44] dBm with step size of 1 dB, each of the other measured L1-RSRP values of the resource(s) associated with the first CMR set is represented by a differential L1-RSRP value, which is quantized to a 4-bit value with step size of 2 dB, relative to the largest measured L1-RSRP value of the resources associated with the first CMR set, while the largest measured L1-RSRP value of the resources associated with the second CMR set is quantized to a 7-bit value in the range [−140, −44] dBm with step size of 1 dB, each of the other measured L1-RSRP values of the resource(s) associated with the second CMR set is represented by a differential L1-RSRP value, which is quantized to a 4-bit value with step size of 2 dB relative to the largest measured L1-RSRP value of the resources associated with the second CMR set.

In some embodiment, the resources associated with a different non-serving cell are associated with a different PCID, and the resources associated with a same non-serving cell are associated with a same PCID.

Referring to FIG. 15, the gNB (i.e. base unit) includes a processor, a memory, and a transceiver. The processors implement a function, a process, and/or a method which are proposed in FIG. 14.

The base unit comprises a transmitter that transmits a configuration of one or multiple CMR sets for channel measurement associated with a CSI-ReportConfig IE with reportQuantity set to ‘cri-RSRP’ or ‘ssb-Index-RSRP’, and nrofReportedRS-Neighboring indicating the number K of beams associated with non-serving cell(s), K is 1 or more; and a receiver that receives a CSI report including K CRIs or SSBRIs and the measured L1-RSRP value of the resource associated with a non-serving cell indicated by each of the K CRIs or SSBRIs.

In one embodiment, one CMR set including resources associated with one or more non-serving cell(s) is configured. The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K. K is configured as a multiple of (P times of) the number of non-serving cell(s), and the resources indicated by every P of the K CRIs or SSBRIs are associated with a different non-serving cell.

In another embodiment, a multiple of CMR sets, each of which includes resources associated with a different non-serving cell, are configured. The resource indicated by each of the K CRIs or SSBRIs is associated with any of the CMR sets. Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In some embodiment, the CSI-ReportConfig IE further has nrofReportedRS indicating the number N of beams associated with a serving cell, N is 1 or more, and the CSI report further includes N CRIs or SSBRIs and the measured L1-RSRP value of the resource associated with the serving cell indicated by each of the N CRIs or SSBRIs.

In one embodiment, one CMR set including two subsets is configured, a first subset of the two subsets includes resources associated with the serving cell and a second subset of the two subsets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell.

In another embodiment, two CMR sets are configured, a first CMR set of the two CMR sets includes resources associated with the serving cell, and a second CMR set of the two CMR sets includes resources associated with the non-serving cell(s). The resource indicated by each of the K CRIs or SSBRIs is associated with any of the non-serving cell(s). Alternatively, if the number of the non-serving cells is equal to or larger than K, the resource indicated by each of the K CRIs or SSBRIs is associated with a different non-serving cell, and if the number of the non-serving cells is smaller than K, K is configured as a multiple of (P times of) the number of non-serving cell(s), and the resources indicated by every P of the K CRIs or SSBRIs are associated with a different non-serving cell. In some embodiment, the largest measured L1-RSRP value of the resources associated with the first CMR set is quantized to a 7-bit value in the range [−140, −44] dBm with step size of 1 dB, each of the other measured L1-RSRP values of the resource(s) associated with the first CMR set is represented by a differential L1-RSRP value, which is quantized to a 4-bit value with step size of 2 dB, relative to the largest measured L1-RSRP value of the resources associated with the first CMR set, while the largest measured L1-RSRP value of the resources associated with the second CMR set is quantized to a 7-bit value in the range [−140, −44] dBm with step size of 1 dB, each of the other measured L1-RSRP values of the resource(s) associated with the second CMR set is represented by a differential L1-RSRP value, which is quantized to a 4-bit value with step size of 2 dB relative to the largest measured L1-RSRP value of the resources associated with the second CMR set.

In some embodiment, the resources associated with a different non-serving cell are associated with a different PCID, and the resources associated with a same non-serving cell are associated with a same PCID.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A user equipment (UE), comprising:a processor; and
a memory coupled with the processor, the processor configured to cause the UE to:
receive a configuration of one channel measurement resource (CMR) set, wherein resources within the CMR set are associated with one or more non-serving cells for channel measurement associated with a CSI-ReportConfig information element (IE) with reportQuantity set to ‘cri-RSRP’ or ‘ssb-Index-RSRP’; and
transmit a channel state information (CSI) report including K>=1 CSI-RS resource indicators (CRIs) or synchronization signal block resource indicators (SSBRIs) and a measured layer 1 reference signal resource power (L1-RSRP) value of the resource associated with a non-serving cell indicated by each of the K CRIs or SSBRIs.

17. The UE of claim 16, wherein,
if the number of the one or more non-serving cells is equal to or larger than K, the resource indicated by each of the K CRIs or SSBRIs is associated with a different non-serving cell, and
if the number of the one or more non-serving cells is smaller than K, K is configured as a multiple of (P times of) the number of non-serving cell(s), and the resources indicated by every P of the K CRIs or SSBRIs are associated with a different non-serving cell.

18. The UE of claim 16, wherein,
multiple CMR sets, each of which includes resources associated with a different non-serving cell, are configured, and
the resource indicated by each of the K CRIs or SSBRIs is associated with any of the CMR sets.

19. The UE of claim 16, wherein,
multiple CMR sets, each of which includes resources associated with a different non-serving cell, are configured, and
if the number of the one or more non-serving cells is equal to or larger than K, the resource indicated by each of the K CRIs or SSBRIs is associated with a different non-serving cell, or
if the number of the one or more non-serving cells is smaller than K, K is configured as a multiple of (P times of) the number of non-serving cell(s), and the resources indicated by every P of the K CRIs or SSBRIs are associated with a different non-serving cell.

20. The UE of claim 16, wherein,
the CSI-ReportConfig IE further has nrofReportedRS indicating the number N of beams associated with a serving cell, where Nis 1 or more, and
the CSI report further includes N CRIs or SSBRIs and the measured L1-RSRP value of the resource associated with the serving cell indicated by each of the N CRIs or SSBRIs.

21. The UE of claim 20, wherein,
when the one CMR set includes two subsets, a first subset of the two subsets includes resources associated with the serving cell and a second subset of the two subsets includes resources associated with the non-serving cell(s), and
the resource indicated by each of the K CRIs or SSBRIs is associated with any of the non-serving cell(s).

22. The UE of claim 20, wherein,
when the one CMR set includes two subsets, a first subset of the two subsets includes resources associated with the serving cell and a second subset of the two subsets includes resources associated with the one or more non-serving cell(s), and
if the number of the non-serving cells is equal to or larger than K, the resource indicated by each of the K CRIs or SSBRIs is associated with a different non-serving cell, or
if the number of the non-serving cells is smaller than K, K is configured as a multiple of
(P times of) the number of non-serving cell(s), and the resources indicated by every P of the K CRIs or SSBRIs are associated with a different non-serving cell.

23. The UE of claim 20, wherein,
when two CMR sets are configured, a first CMR set of the two CMR sets includes resources associated with the serving cell, and a second CMR set of the two CMR sets includes resources associated with the non-serving cell(s), and
the resource indicated by each of the K CRIs or SSBRIs is associated with any of the one or more non-serving cell(s).

24. The UE of claim 20, wherein,
when two CMR sets are configured, a first CMR set of the two CMR sets includes resources associated with the serving cell, and a second CMR set of the two CMR sets includes resources associated with the non-serving cell(s), and
if the number of the non-serving cells is equal to or larger than K, the resource indicated by each of the K CRIs or SSBRIs is associated with a different non-serving cell, or
if the number of the non-serving cells is smaller than K, K is configured as a multiple of (P times of) the number of non-serving cell(s), and the resources indicated by every P of the K CRIs or SSBRIs are associated with a different non-serving cell.

25. The UE of claim 16, wherein,
the resources associated with a different non-serving cell are associated with a different physical cell ID (PCID), and
the resources associated with a same non-serving cell are associated with a same PCID.

26. The UE of claim 20, wherein,
when two CMR sets are configured, a first CMR set of the two CMR sets includes resources associated with the serving cell, and a second CMR set of the two CMR sets includes resources associated with the non-serving cell(s),
the largest measured L1-RSRP value of the resources associated with the first CMR set is
quantized to a 7-bit value in the range [−140, −44] dBm with step size of 1 dB, each of the other measured L1-RSRP values of the resource(s) associated with the first
CMR set is represented by a differential L1-RSRP value, which is quantized to a 4-bit value with step size of 2 dB, relative to the largest measured L1-RSRP value of the resources associated with the first CMR set,
the largest measured L1-RSRP value of the resources associated with the second CMR
set is quantized to a 7-bit value in the range [−140, −44] dBm with step size of 1 dB, each of the other measured L1-RSRP values of the resource(s) associated with the second
CMR set is represented by a differential L1-RSRP value, which is quantized to a 4-bit value with step size of 2 dB relative to the largest measured L1-RSRP value
of the resources associated with the second CMR set.

27. A base unit, comprising:
a processor; and
a memory coupled with the processor, the processor configured to cause the base unit to:
transmit a configuration of one channel measurement resource (CMR) set associated with one or more non-serving cells for channel measurement associated with a CSI-ReportConfig information element (IE) with reportQuantity set to ‘cri-RSRP’ or ‘ssb-Index-RSRP’; and
receive a CSI report including K>1 CSI-RS resource indicators (CRIs) or synchronization signal block resource indicators (SSBRIs) and a measured layer 1 reference signal resource power (L1-RSRP) value of the resource associated with a non-serving cell indicated by each of the K CRIs or SSBRIs.

28. The base unit of claim 27, wherein,
if the number of the one or more non-serving cells is equal to or larger than K, the resource indicated by each of the K CRIs or SSBRIs is associated with a different non-serving cell, and
if the number of the one or more non-serving cells is smaller than K, K is configured as a multiple of (P times of) the number of non-serving cell(s), and the resources indicated by every P of the K CRIs or SSBRIs are associated with a different non-serving cell.

29. The base unit of claim 27, wherein,
multiple CMR sets, each of which includes resources associated with a different non-serving cell, are configured, and
the resource indicated by each of the K CRIs or SSBRIs is associated with any of the CMR sets.

30. The base unit of claim 27, wherein,
multiple CMR sets, each of which includes resources associated with a different non-serving cell, are configured, and
if the number of the one or more non-serving cells is equal to or larger than K, the resource indicated by each of the K CRIs or SSBRIs is associated with a different non-serving cell, or
if the number of the one or more non-serving cells is smaller than K, K is configured as a multiple of (P times of) the number of non-serving cell(s), and the resources indicated by every P of the K CRIs or SSBRIs are associated with a different non-serving cell.

31. The base unit of claim 27, wherein,
the CSI-ReportConfig IE further has nrofReportedRS indicating the number N of beams associated with a serving cell, where Nis 1 or more, and
the CSI report further includes N CRIs or SSBRIs and the measured L1-RSRP value of the resource associated with the serving cell indicated by each of the N CRIs or SSBRIs.

32. The base unit of claim 27, wherein,
the resources associated with a different non-serving cell are associated with a different physical cell ID (PCID), and
the resources associated with a same non-serving cell are associated with a same PCID.

33. A processor for wireless communication, comprising:
at least one controller coupled with at least one memory and configured to cause the processor to:
receive a configuration of one channel measurement resource (CMR) set, wherein resources within the CMR set are associated with one or more non-serving cells for channel measurement associated with a CSI-ReportConfig information element (IE) with reportQuantity set to ‘cri-RSRP’ or ‘ssb-Index-RSRP’; and
transmit a channel state information (CSI) report including K>CSI-RS resource indicators (CRIs) or synchronization signal block resource indicators (SSBRIs) and a measured layer 1 reference signal resource power (L1-RSRP) value of the resource associated with a non-serving cell indicated by each of the K CRIs or SSBRIs.

34. The processor of claim 33, wherein
if the number of the one or more non-serving cells is equal to or larger than K, the resource indicated by each of the K CRIs or SSBRIs is associated with a different non-serving cell, and
if the number of the one or more non-serving cells is smaller than K, K is configured as a multiple of (P times of) the number of non-serving cell(s), and the resources indicated by every P of the K CRIs or SSBRIs are associated with a different non-serving cell.

35. A method performed by a user equipment (UE), the method comprising:
receiving a configuration of one channel measurement resource (CMR) set, wherein resources within the CMR set are associated with one or more non-serving cells for channel measurement associated with a CSI-ReportConfig information element (IE) with reportQuantity set to ‘cri-RSRP’ or ‘ssb-Index-RSRP’; and
transmitting a channel state information (CSI) report including K>CSI-RS resource indicators (CRIs) or synchronization signal block resource indicators (SSBRIs) and a measured layer 1 reference signal resource power (L1-RSRP) value of the resource associated with a non-serving cell indicated by each of the K CRIs or SSBRIs.
